(19) United States
(12) Patent Application Publication
(10) Pub. No.: US 2018/0277003 A1
(43) Pub. Date: Sep. 27, 2018

(54) LEARNING APPARATUS BASED ON DIGITAL BOOKS

(71) Applicant: ZHENGFANG MA, SHANGHAI (CN)

(72) Inventors: ZHENGFANG MA, SHANGHAI (CN); HUIYAN WANG, SHANGHAI (CN)

(73) Assignee: ZHENGFANG MA, SHANGHAI (CN)

(21) Appl. No.: 15/740,917

(22) PCT Filed: Jun. 30, 2016
(86) PCT No.: PCT/CN2016/087834

§ 371 Date: Jun. 9, 2018

(30) Foreign Application Priority Data
Jul. 1, 2015 (CN) 201510378394.9

(51) Int. Cl. G09B 5/08; G06T 11/20

(52) U.S. Cl. CPC G09B 5/08; H04L 67/1097; G06T 11/206

(57) ABSTRACT

A digital-book-based learning apparatus. The network terminal comprises an image-text display module, configured to display content of a digital book on a display screen of the network terminal; a knowledge-point display module, configured to display a knowledge point structure and knowledge point content of the digital book; and a first transmission module, configured to perform data transmission with the server. The server comprises: a digital-book storage module, configured to store the digital book; a knowledge-point storage module, configured to store a knowledge point structure and knowledge point content that are preseted and corresponded to the digital book, wherein the knowledge point structure comprises a classification, a structural relationship, and a label of a knowledge point; and a second transmission module, configured to perform data transmission with the network terminal. The knowledge point structure is preseted in the digital book.

### BACKGROUND OF THE PRESENT INVENTION

### Field of Invention

The present invention relates to an apparatus for a digital book, and in particular, to an apparatus based on a network terminal and facilitating reading, understanding, and learning of a digital book.

### Description of Related Arts

Book reading has been electronized in current information age. Ebooks (referred to as digital books in the present invention) are a conventional form, and users read the digital books on electronic reading devices. For example, a user may read a digital book on a computer installed with digital-book reading software, or may read a digital book on a mobile phone installed with a digital-book reading APP, or may read a digital book on a dedicated ebook reading device (such as Kindle).

However, regardless of a device on which the user reads the digital book, a function provided by the device or corresponding software is only reading. A slightly higher-level device further provides an editing function, and the user may perform editing operations such as adding a comment, a note, or a bookmark to the read digital book or drawing a line on the read digital book. Although these auxiliary editing operations help the user to understand the digital book, such auxiliary functions are still stuck at the level of mastering local content or local information instead of wholly macroscopically understanding and mastering content of the book or a knowledge system related to the book.

On the other hand, like conventional books, digital books generally have a catalogue part. The catalogue part is more like an index of content, and a main object thereof is that a user can quickly find interested content. However, it is far insufficient to quickly understand a book by using a catalogue because the catalogue is for indexing of content instead of understanding of the content.

Currently, a novel digital-book reading apparatus is urgent to the industry, which facilitates quick understanding of content of a digital book in addition to a basic function of reading the digital book.

### Summary of the Present Invention

The following gives a brief summary of one or more aspects, to provide basic understanding of the aspects. The summary is not a detailed overview of all conceived aspects, and is neither intended to point out critical or decisive factors of all the aspects nor attempts to define the scope of any or all of the aspects. A unique object thereof is to provide some concepts of one or more aspects in a simplified form, to be a foreword to more detailed description that is subsequently provided.

An object of the present invention is to resolve the foregoing problems. The present invention provides a digital-book-based learning apparatus, so as to provide functions of learning and understanding knowledge points in content of a digital book in addition to a function of normally reading the digital book.

A technical solution of the present invention is: the present invention discloses a digital-book-based learning apparatus, comprising a network terminal and a server, wherein
the network terminal comprises:
an image-text display module, configured to display content of a digital book on a display screen of the network terminal in an image-text manner;
a knowledge-point display module, configured to display a knowledge point structure and knowledge point content of the digital book; and
a first transmission module, configured to perform data transmission with the server; and
the server comprises:
a digital-book storage module, configured to store the digital book;
a knowledge-point storage module, configured to store a knowledge point structure and knowledge point content that are preseted and corresponded to the digital book, where the knowledge point structure comprises a classification, a structural relationship, and a label of a knowledge point; and
a second transmission module, configured to perform data transmission with the network terminal.

According to an embodiment of the digital-book-based learning apparatus consistent with the present invention, the network terminal further comprises:
a knowledge-point reconstruction module, configured to reconstruct, based on understanding of a user on the content of the digital book, the knowledge point structure corresponding to the digital book.

According to an embodiment of the digital-book-based learning apparatus consistent with the present invention, a knowledge point structure reconstructed by the user in the knowledge-point reconstruction module is transmitted to the knowledge-point storage module of the server by the first transmission module for storage.

According to an embodiment of the digital-book-based learning apparatus consistent with the present invention, the knowledge-point display module comprises:
a knowledge-point structure display unit, configured to display the knowledge point structure corresponding to the digital book on a first part of the display screen of the network terminal in a first display mode, where the displayed knowledge point structure comprises a current knowledge point; and
a knowledge-point content display unit, configured to display content of the current knowledge point on a second part of the display screen of the network terminal.

According to an embodiment of the digital-book-based learning apparatus consistent with the present invention, the knowledge-point structure display unit comprises a star graph display unit, where the star graph display unit is configured to display the knowledge point structure on the first part of the display screen of the network terminal in a star graph display mode.

According to an embodiment of the digital-book-based learning apparatus consistent with the present invention, the knowledge-point structure display unit is further configured to display the knowledge point structure on the first part of the display screen of the network terminal in a second display mode, where the displayed knowledge point structure comprises the current knowledge point; and
the network terminal further comprises:
a display-mode switching module, configured to receive an input of a user to perform switching between the first display mode and the second display mode.

According to an embodiment of the digital-book-based learning apparatus consistent with the present invention, the second display mode is a tree graph display mode, the knowledge-point structure display unit further comprises a tree graph display unit, and the tree graph display unit is configured to display the knowledge point structure on the first part of the display screen of the network terminal in a tree-graph display mode.

According to an embodiment of the digital-book-based learning apparatus consistent with the present invention, the structural relationship of the knowledge point is displayed by using the knowledge-point structure display unit in the star graph display mode, N parent nodes, N neighboring brother nodes, and N child nodes using the current knowledge point as a center are displayed on the first part of the display screen of the network terminal, where N is a natural number greater than or equal to 1, the label of the knowledge point is displayed at the node in the star graph, and a connecting line or an arrow between the nodes indicate a structural relationship between knowledge points.

According to an embodiment of the digital-book-based learning apparatus consistent with the present invention, the node in the star graph is indicated by a rectangular box, text in the rectangular box is the label of the knowledge point, and brightness of an edge of the rectangular box indicates whether there is structural relationship between the knowledge points.

According to an embodiment of the digital-book-based learning apparatus consistent with the present invention, the network terminal further comprises:
a gesture identification module, configured to: identify an operation gesture of a user on the star graph displayed on the first part of the display screen of the network terminal, and move, based on the gesture, the node displayed in the star graph.

According to an embodiment of the digital-book-based learning apparatus consistent with the present invention, the knowledge-point structure display unit is further configured to display the knowledge point structure on the first part of the display screen of the network terminal in a third display mode, where the third display mode is an implication graph display mode; the knowledge-point structure display unit further comprises an implication graph display unit, and the implication graph display unit is configured to display the knowledge point structure on the first part of the display screen of the network terminal in the implication graph display mode; and the display-mode switching module is configured to receive the input of the user to perform switching between the first display mode, the second display mode, and the third display mode.

Compared with the prior art, the present invention has the following beneficial effects: In the present invention, the knowledge point structure is preseted in the digital book. Each knowledge point in the structure comes from the content of the book. Generally, a writer sorts out content of a digital book, decomposes the content to obtain several knowledge points, and then performs structured processing on the knowledge points, to form a knowledge point structure. The knowledge point structure completed by the writer is attached to the digital book. A user may refer to the knowledge point structure while reading image-text content of the book, so as to facilitate macroscopic understanding of the entire book. In addition, the apparatus further provides the user with a function of reconstructing the knowledge point structure of the book by himself/herself. The user may reconstruct, based on his/her own understanding, the knowledge point structure, and share the knowledge point structure to another user after uploading the knowledge point structure to the server.

### BRIEF DESCRIPTION OF THE DRAWINGS

FIG. 1A shows a schematic diagram of a first embodiment of a digital-book-based learning apparatus according to the present invention.

FIG. 1B shows a schematic diagram of a second embodiment of a digital-book-based learning apparatus according to the present invention.

FIG. 2A shows a schematic diagram of a third embodiment of a digital-book-based learning apparatus according to the present invention.

FIG. 2B shows a schematic diagram of a fourth embodiment of a digital-book-based learning apparatus according to with the present invention.

FIG. 3A shows a schematic diagram of a fifth embodiment of a digital-book-based learning apparatus according to the present invention.

FIG. 3B shows a schematic diagram of a sixth embodiment of a digital-book-based learning apparatus according to the present invention.

FIG. 4A to FIG. 4C show exemplary diagram of star graphs which show a knowledge point structure.

FIG. 5 shows an exemplary diagram of a tree graph which shows a knowledge point structure.

FIG. 6A and FIG. 6B show exemplary diagram of implication diagrams which show a knowledge point structure.

### DETAILED DESCRIPTION OF THE PREFERRED EMBODIMENTS

After detailed description of embodiments of the present disclosure is read with reference to the accompanying drawings, the foregoing features and advantages consistent with the present invention can be better understood. In the accompanying drawings, components are not necessarily drawn to scale, and components having similar related characteristics or features may have same or similar reference numerals.

### First Embodiment of a Digital-Book-Based Learning Apparatus

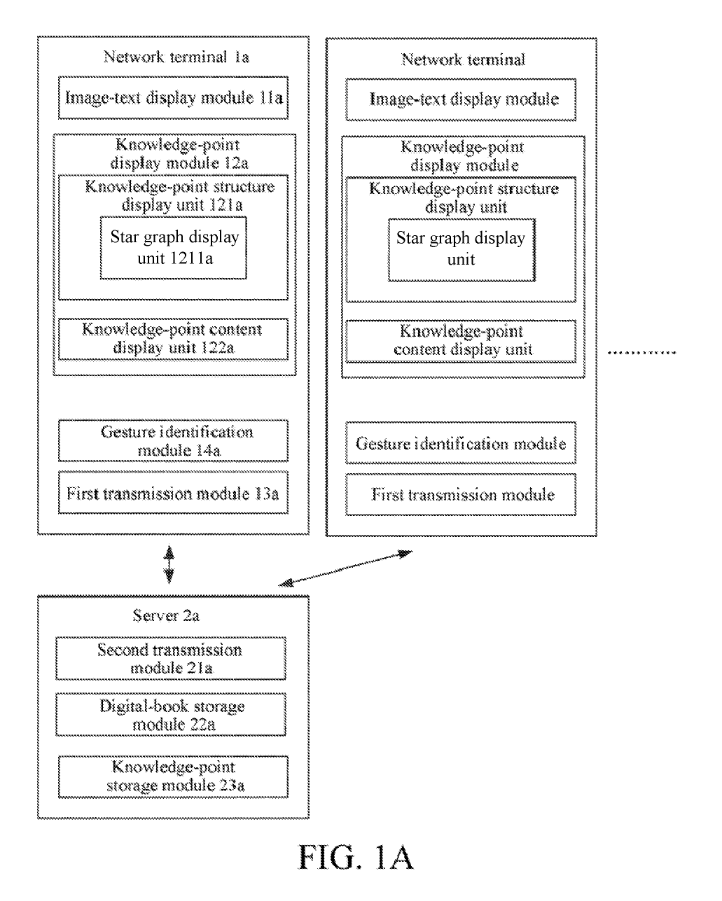

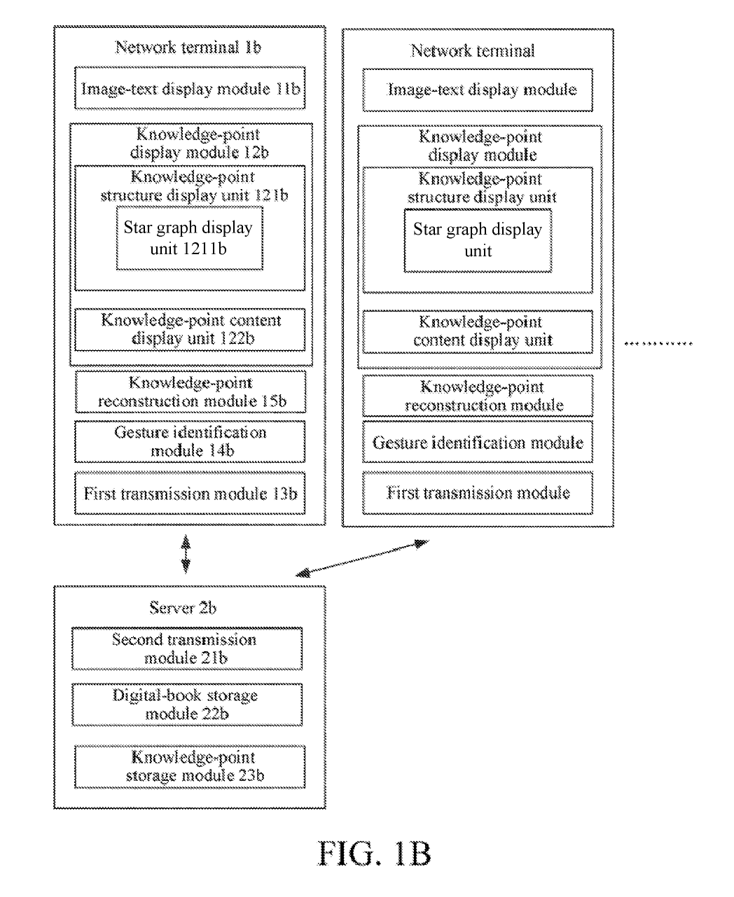

FIG. 1A shows the principle of the first embodiment of the digital-book-based learning apparatus according to the present invention.

The digital-book-based learning apparatus in this embodiment comprises two parts: a network terminal 1a and a server 2a. The network terminal 1a may be a computer having a network function, or a smartphone, and establishes a communication connection to the server 2a by using the Internet or a mobile Internet.

The server 2a comprises a second transmission module 21a, a digital-book storage module 22a, and a knowledge-point storage module 23a. The second transmission module 21a is configured to implement data transmission between the server 2a and the network terminal 1a. The digital-book storage module 22a is configured to store a digital book. The knowledge-point storage module is configured to store a knowledge point structure and knowledge point content that are preset and corresponded to the digital book. The knowledge point structure comprises a classification, a structural relationship, and a label of a knowledge point. The classification of the knowledge point is a category of the knowledge point defined by an editor of the knowledge point. For example, “Belt and Road” is classified into a category of “economy” under editing of a user A, but may be classified into a category of “politics” under editing of a user B. A same knowledge point may be classified into different classifications due to different understandings of different users.

The label of the knowledge point is similar to a name of the knowledge point. For example, “Belt and Road” is a label of the knowledge point. The content of the knowledge point is a specific definition of the knowledge point. For example, a specific meaning of “Belt and Road” is content under the label of “Belt and Road”.

The structural relationship of the knowledge point is a logical relationship between knowledge points. The logical relationship is preferably expressed by using a tree data structure. Parent-child nodes are used to indicate a hyponymy relationship between the knowledge points, and brother nodes are used to indicate a parallel relationship between knowledge points. For example, a parent node of “Belt and Road” is “National Strategy”; child nodes of “Belt and Road” are “Silk Road Economic Belt”, “Maritime Silk Road”, and “Asian Infrastructure Investment Bank”; brother nodes of “Belt and Road” are “Beijing-Tianjin-Hebei Integration”, “Yangtze River Economic Zone”, “Free Trade Zone”, “Western Region Development”, “Revitalization of Northeast”, and the like.

When entering a knowledge point, an editor further enters a relationship between the knowledge point and other knowledge points in addition to content of the knowledge point. For example, for a currently entered knowledge point A and an already existing knowledge point B, a relationship between the knowledge point A and the knowledge point B may be entered while the knowledge point A is entered, and the relationship may be classified into: no relationship between A and B, or a parallel relationship between A and B. If a parallel relationship exists between A and B, it indicates that granularities of A and B are the same. The parallel relationship may be further classified into three types: a causal relationship, no causal relationship but with a learning sequence, no causal relationship and no learning sequence.

No relationship or a parallel relationship (the parallel relationship is further classified into three types: a causal relationship, no causal relationship but a learning sequence, no causal relationship and no learning sequence) also exists between the currently recorded knowledge point A and a plurality of already existing knowledge points B, C, D, . . . In addition, an implication/subordinate relationship exists between the knowledge point A and the plurality of already existing knowledge points B, C, D, . . .

Each knowledge point structure and knowledge point content in the module correspond to a digital book. The knowledge point structure and knowledge point content preset in the module are preferably a knowledge point structure and knowledge point content that are established by a writer as an editor of the knowledge point structure. For example, the writer of Thirty Years of Agitation is Wu Xiaobo, and a digital book of Thirty Years of Agitation is stored in the digital-book storage module 22a. Correspondingly, the knowledge-point storage module 23a stores a knowledge point structure and knowledge point content that correspond to the book and are established by Wu Xiaobo according to knowledge points related to Thirty Years of Agitation.

The network terminal 1a comprises an image-text display module 11a, a knowledge-point display module 12a, and a first transmission module 13a. The first transmission module 13a is configured to implement data transmission between the network terminal 1a and the server 2a. The image-text display module 11a displays content of the digital book on a display screen of the network terminal 1a in an image-text manner. The digital book stored in the digital-book storage module 22a of the server is stored in the network terminal 1a by the second transmission module 21a and the first transmission module 13a, and is displayed, by the image-text display module 11a, on the display screen in a commonest image-text manner of digital books for a user to read.

In this case, the knowledge point structure stored in the knowledge-point storage module 23a of the server 2a and corresponding to the digital book is also stored in the network terminal 1a by the second transmission module 21a and the first transmission module 13a, and the knowledge point structure and knowledge point content corresponding to the digital book are then displayed by using the knowledge-point display module 12a.

The display of the knowledge point on the network terminal comprises two parts: one part is a position of a current knowledge point in an entire knowledge structure and relationships between the current knowledge point and other neighboring knowledge points, that is, a display of the knowledge point structure. The other part is specific content of the current knowledge point, that is, a display of the content of the knowledge point.

The knowledge-point display module 12a is further provided with a knowledge-point structure display unit 121a and a knowledge-point content display unit 122a. The knowledge-point structure display unit 121a displays the knowledge point structure corresponding to the digital book on a first part of the display screen of the network terminal in a first display mode, wherein the displayed knowledge point structure comprises the current knowledge point. The knowledge-point content display unit 122a displays the content of the current knowledge point on a second part of the display screen of the network terminal.

The display screen of the network terminal 1a comprises two parts, for example, an upper part and a lower part, or a left part and a right part. In this embodiment, the upper part and the lower part are used as an example for description. In this embodiment, the knowledge-point structure display unit 121a is provided with a star graph display unit 1211a. The star graph display unit 1211a is configured to display the knowledge point structure on the upper part of display screen of the network terminal in a star graph display mode. The displayed knowledge point structure comprises the current knowledge point. Correspondingly, the knowledge-point content display unit 122a displays the content of the current knowledge point on the lower part of the display screen of the network terminal.

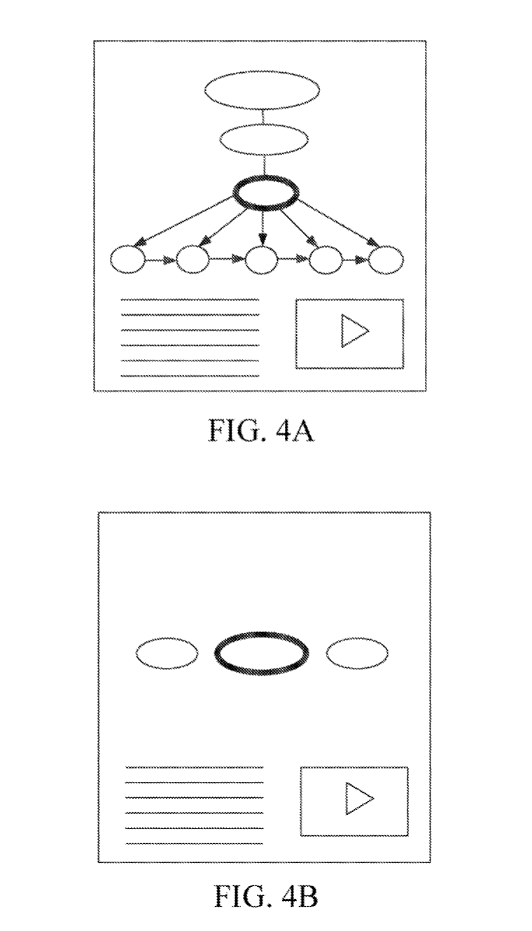

The knowledge point structure displayed in the star graph display mode is shown in FIG. 4A to FIG. 4C. In FIG. 4A, a structure of a knowledge point displayed in the star graph is displayed on the upper part of the display screen. The current knowledge point is located in the center, an upper level of the current knowledge point is a parent node, a further upper level is a grandparent node (that is, a parent node of the parent node), and so on. A lower level of the current knowledge point is child nodes, a further lower level is grandchild nodes (that is, child nodes of the child nodes), and so on. However, because there are too many nodes when it comes to the grandchild node, generally, the current knowledge point is preferably unfolded to the level of the child nodes. A left node or a right node of the current knowledge point is a brother node. A connecting line is used between knowledge points to indicate a relationship between the knowledge points. In terms of a data structure, the relationship is the foregoing parent-child relationship, brother relationship, or the like. In terms of a logical relationship, the relationship may be an inclusion relationship, a time sequence relationship, a causal relationship, or the like. Preferably, an arrow direction may be further used to further indicate a cause and an effect in the causal relationship. A double-headed arrow may be used to indicate reciprocal causation.

The node in the star graph may be indicated by using a geometric shape. In this embodiment, the node is indicated by using a rectangular box. Text in the rectangular box is a label name of the knowledge point, and brightness of four edges of the rectangular box may indicate whether a relationship in terms of the knowledge point structure exists between the knowledge point and other knowledge point. For example, if a top edge of the rectangular box is highlighted, it indicates that a parent node exists above the rectangular box; if a bottom edge of the rectangular box is gray, it indicates that no child node exists below the rectangular box; similarly, a lateral edge of the rectangular box is used to indicate whether a brother node exists.

Using brightness of a line to indicate whether there is a neighboring parent node, a child node, or a brother node has an actual meaning. The star graph is usually suitable for being displayed on a touchscreen of a smartphone with a small size of screen. Therefore, only a local structure around the current knowledge point in an entire knowledge point structure system can be displayed on the screen. When a user needs to search for a knowledge point not displayed on a current interface, the user may directly move, on the touchscreen by using a gesture operation, the knowledge point displayed on the screen. The brightness of the side of the rectangular box is used to inform moving boundary. When a side of the rectangular box is highlighted, the user is informed that another node associated with the current knowledge point exists in a direction corresponding to the edge. When an edge of the rectangular box is gray, the user is informed that no other node associated with the current knowledge point exists in a direction corresponding to the edge.

For the gesture operation mentioned in the previous paragraph, correspondingly, the network terminal 1a may be further provided with a gesture identification module 14a. The gesture identification module 14a identifies an operation gesture of the user on the star graph displayed on the first part of the display screen of the network terminal, and moves, based on the gesture, the node displayed in the star graph.

For example, when the user reads the digital book of Thirty Years of Agitation, and searches for a keyword “household production” in the corresponding knowledge point structure, the network terminal executes, based on the search, a search strategy to find a knowledge point of “household production”, captures, based on displaying setting of the start graph (for example, at most 5 nodes are displayed at a level of the current knowledge point, at most 3 levels of parent nodes above the current knowledge point are displayed, at most one lower level of child nodes are displayed, and a knowledge point used as a search result is placed in the center position of the star graph), a local structure of a knowledge point system comprising the current knowledge point is captured, and correspondingly displayed on the touchscreen. If a gesture operation of the user on the touchscreen is received, the network terminal 1a re-captures, based on the gesture, a local structure of a corresponding knowledge point system from the knowledge point structure stored in the network terminal, and updates display on the touchscreen.

The knowledge-point content display unit 122a displays the content of the current knowledge point on the lower part of the display screen of the network terminal. The content comprises text content and multimedia content of the knowledge point. For example, in FIG. 4A, a left part of the lower part is the text content of the knowledge point, and a right part of the lower part is the multimedia content of the knowledge point.

FIG. 4B shows a case in which the current knowledge point is located at the top level in the entire knowledge point structure system. In this case, the user cannot move the current knowledge point upward by using a gesture any more. FIG. 4C shows a case in which the current knowledge point is located at a bottom level in the entire knowledge point structure system. In this case, the user cannot move the current knowledge point downward by using a gesture any more.

In this embodiment, the network terminal 1a displays the local structure comprising the current knowledge point on the screen by using the star graph, and displays the content of the current knowledge point at the same time. Displaying of the star graph is very suitable for a device with a small size of screen, and has a better application effect in a smartphone.

### Second Embodiment of a Digital-Book-Based Learning Apparatus

FIG. 1B shows the principle of the second embodiment of the digital-book-based learning apparatus according to the present invention.

The digital-book-based learning apparatus in this embodiment comprises two parts: a network terminal 1b and a server 2b. The network terminal 1b may be a computer having a network function, or a smartphone, and establishes a communication connection to the server 2b by using the Internet or a mobile Internet.

The server 2b comprises a second transmission module 21b, a digital-book storage module 22b, and a knowledge-point storage module 23b. The second transmission module 21b is configured to implement data transmission between the server 2b and the network terminal 1b. The digital-book storage module 22b is configured to store a digital book. The knowledge-point storage module 23b is configured to store a knowledge point structure and knowledge point content that are preseted and corresponded to the digital book. The knowledge point structure comprises a classification, a structural relationship, and a label of a knowledge point. The classification of the knowledge point is a category of the knowledge point defined by an editor of the knowledge point. For example, “Belt and Road” is classified into a category of “economy” under editing of a user A, and may be classified into a category of “politics” under editing of a user B. A same knowledge point may be classified into different classifications due to different understandings of different users.

The label of the knowledge point is similar to a name of the knowledge point. For example, “Belt and Road” is a label of the knowledge point. The content of the knowledge point is a specific definition of the knowledge point. For example, a specific meaning of “Belt and Road” is content under the label of “Belt and Road”.

The structural relationship of the knowledge point is a logical relationship between knowledge points. The logical relationship is preferably indicated by using a tree data structure. Parent-child nodes are used to indicate a hyponymy relationship between the knowledge points, and brother nodes are used to indicate a parallel relationship between knowledge points. For example, a parent node of “Belt and Road” is “National Strategy”; child nodes of “Belt and Road” are “Silk Road Economic Belt”, “Maritime Silk Road”, and “Asian Infrastructure Investment Bank”; brother nodes of “Belt and Road” are “Beijing-Tianjin-Hebei Integration”, “Yangtze River Economic Zone”, “Free Trade Zone”, “Western Region Development”, “Revitalization of Northeast”, and the like.

When entering a knowledge point, an editor further enters a relationship between the knowledge point and other knowledge points in addition to content of the knowledge point. For example, for a currently entered knowledge point A and an already existing knowledge point B, a relationship between the knowledge point A and the knowledge point B may be entered while the knowledge point A is entered, and the relationship may be classified into: no relationship between A and B, or a parallel relationship between A and B. If a parallel relationship exists between A and B, it indicates that granularities of A and B are the same. The parallel relationship may be further classified into three types: a causal relationship, no causal relationship but with a learning sequence, no causal relationship and no learning sequence.

No relationship or a parallel relationship (the parallel relationship is further classified into three types: a causal relationship, no causal relationship but a learning sequence, no causal relationship and no learning sequence) also exists between the currently recorded knowledge point A and a plurality of already existing knowledge points B, C, D, . . . In addition, an implication/subordinate relationship exists between the knowledge point A and the plurality of already existing knowledge points B, C, D, . . .

Each knowledge point structure and knowledge point content in the module correspond to a digital book. The knowledge point structure and knowledge point content preset in the module are preferably a knowledge point structure and knowledge point content that are established by a writer as an editor of the knowledge point structure. For example, the writer of Thirty Years of Agitation is Wu Xiaobo, and a digital book of Thirty Years of Agitation is stored in the digital-book storage module 22b. Correspondingly, the knowledge-point storage module 23b stores a knowledge point structure and knowledge point content that correspond to the book and are established by Wu Xiaobo according to knowledge points related to Thirty Years of Agitation.

The network terminal 1b comprises an image-text display module 11b, a knowledge-point display module 12b, a first transmission module 13b, and a knowledge-point reconstruction module 15b. The first transmission module 13b is configured to implement data transmission between the network terminal 1b and the server 2b. The image-text display module 11b displays content of the digital book on a display screen of the network terminal 1b in an image-text manner. The digital book stored in the digital-book storage module 22b of the server is stored in the network terminal 1b by the second transmission module 21b and the first transmission module 13b, and is displayed, by the image-text display module 11b, on the display screen in a commonest image-text manner of digital books for a user to read.

In this case, the knowledge point structure stored in the knowledge-point storage module 23b of the server 2b and corresponding to the digital book is also stored in the network terminal 1b by the second transmission module 21b and the first transmission module 13b, and the knowledge point structure and knowledge point content corresponding to the digital book are then displayed by using the knowledge-point display module 12b.

The displaying of the knowledge point on the network terminal comprises two parts: one part is a position of a current knowledge point in an entire knowledge structure and relationships between the current knowledge point and other neighboring knowledge points, that is, a display of the knowledge point structure. The other part is specific content of the current knowledge point, that is, a display of the content of the knowledge point.

The knowledge-point display module 12b is further provided with a knowledge-point structure display unit 121b and a knowledge-point content display unit 122b. The knowledge-point structure display unit 121b displays the knowledge point structure corresponding to the digital book on a first part of the display screen of the network terminal in a first display mode, wherein the displayed knowledge point structure comprises the current knowledge point. The knowledge-point content display unit 122b displays the content of the current knowledge point on a second part of the display screen of the network terminal.

The display screen of the network terminal 1b comprises two parts, for example, an upper part and a lower part, or a left part and a right part. In this embodiment, the upper part and the lower part are used as an example for description. In this embodiment, the knowledge-point structure display unit 121b is provided with a star display unit 1211b. The star display unit 1211b displays the knowledge point structure on the upper part of display screen of the network terminal in a stargraph display mode. The displayed knowledge point structure comprises the current knowledge point. Correspondingly, the knowledge-point content display unit 122b displays the content of the current knowledge point on the lower part of the display screen of the network terminal.

The knowledge point structure displayed in the stargraph display mode is shown in FIG. 4A to FIG. 4C. In FIG. 4A, a structure of a knowledge point displayed in the star graph is displayed on the upper part of the display screen. The current knowledge point is located in the center, an upper level of the current knowledge point is a parent node, a further upper level is a grandparent node (that is, a parent node of the parent node), and so on. A lower level of the current knowledge point is child nodes, a further lower level is grandchild nodes (that is, child nodes of the child nodes), and so on. However, because there are too many nodes when it comes to the grandchild node, generally, the current knowledge point is preferably unfolded to the level of the child nodes. A left node or a right node of the current knowledge point is a brother node. A connecting line is used between knowledge points to indicate a relationship between the knowledge points. In terms of a data structure, the relationship is the foregoing parent-child relationship, brother relationship, or the like. In terms of a logical relationship, the relationship may be an inclusion relationship, a time sequence relationship, a causal relationship, or the like. Preferably, an arrow direction may be further used to further indicate a cause and an effect in the causal relationship. A double-headed arrow may be used to indicate reciprocal causation.

The node in the star graph may be indicated by using a geometric shape. In this embodiment, the node is indicated by using a rectangular box. Text in the rectangular box is a label name of the knowledge point, and brightness of four edges of the rectangular box may indicate whether a relationship in terms of the knowledge point structure exists between the knowledge point and other knowledge points. For example, if a top edge of the rectangular box is highlighted, it indicates that a parent node exists above the rectangular box; if a bottom edge of the rectangular box is gray, it indicates that no child node exists below the rectangular box; similarly, a lateral edge of the rectangular box is used to indicate whether a brother node exists.

Using brightness of a line to indicate whether there is a neighboring parent node, a child node, or a brother node has an actual meaning. The star graph is usually suitable for being displayed on a touchscreen of a smartphone with a small size of screen. Therefore, only a local structure around the current knowledge point in an entire knowledge point structure system can be displayed on the screen. When a user needs to search for a knowledge point not displayed on a current interface, the user may directly move, on the touchscreen by using a gesture operation, the knowledge point displayed on the screen. The brightness of the side of the rectangular box is used to inform moving boundary. When a side of the rectangular box is highlighted, the user is informed that other node associated with the current knowledge point exists in a direction corresponding to the edge. When an edge of the rectangular box is gray, the user is informed that no other node associated with the current knowledge point exists in a direction corresponding to the edge.

For the gesture operation mentioned in the previous paragraph, correspondingly, the network terminal 1b may be further provided with a gesture identification module 14b. The gesture identification module 14b identifies an operation gesture of the user on the star graph displayed on the first part of the display screen of the network terminal, and moves, based on the gesture, the node displayed in the star graph.

For example, when the user reads the digital book of Thirty Years of Agitation, and searches for a keyword “household production” in the corresponding knowledge point structure, the network terminal executes, based on the search, a search strategy to find a knowledge point of “household production”, captures, based on displaying setting of the start graph (for example, at most 5 nodes are displayed at a level of the current knowledge point, at most 3 levels of parent nodes above the current knowledge point are displayed, at most one lower level of child nodes are displayed, and a knowledge point used as a search result is placed in the center position of the star graph), a local structure of a knowledge point system comprising the current knowledge point is captured, and correspondingly displayed on the touchscreen. If a gesture operation of the user on the touchscreen is received, the network terminal 1b re-captures, based on the gesture, a local structure of a corresponding knowledge point system from the knowledge point structure stored in the network terminal, and updates display on the touchscreen.

The knowledge-point content display unit 122b displays the content of the current knowledge point on the lower part of the display screen of the network terminal. The content comprises text content and multimedia content of the knowledge point. For example, in FIG. 4A, a left part of the lower part is the text content of the knowledge point, and a right part of the lower part is the multimedia content of the knowledge point.

FIG. 4B shows a case in which the current knowledge point is located at the top level in the entire knowledge point structure system. In this case, the user cannot move the current knowledge point upward by using a gesture any more. FIG. 4C shows a case in which the current knowledge point is located at a bottom level in the entire knowledge point structure system. In this case, the user cannot move the current knowledge point downward by using a gesture any more.

In this embodiment, the network terminal 1b displays the local structure comprising the current knowledge point on the screen by using the star graph, and displays the content of the current knowledge point at the same time. Displaying of the star graph is very suitable for a device with a small size of screen, and has a better application effect in a smartphone.

The embodiment differs from the first embodiment in that: a knowledge-point reconstruction module 15b is provided in the network terminal 1b. All the foregoing contents are understandings of the user based on the knowledge point structure given by the writer when reading the digital book. The knowledge point reconstruction module 15b reconstructs, based on understanding of the user on the content of the digital book, the knowledge point structure corresponding to the digital book. A reconstructed knowledge point structure coexists with the presetting knowledge point structure of the writer in a system, and is stored in the network terminal. The knowledge point structure reconstructed by the user is transmitted to the knowledge-point storage module 23b of the server 2b by using the first transmission module for storage.

### Third Embodiment of a Digital-Book-Based Learning Apparatus

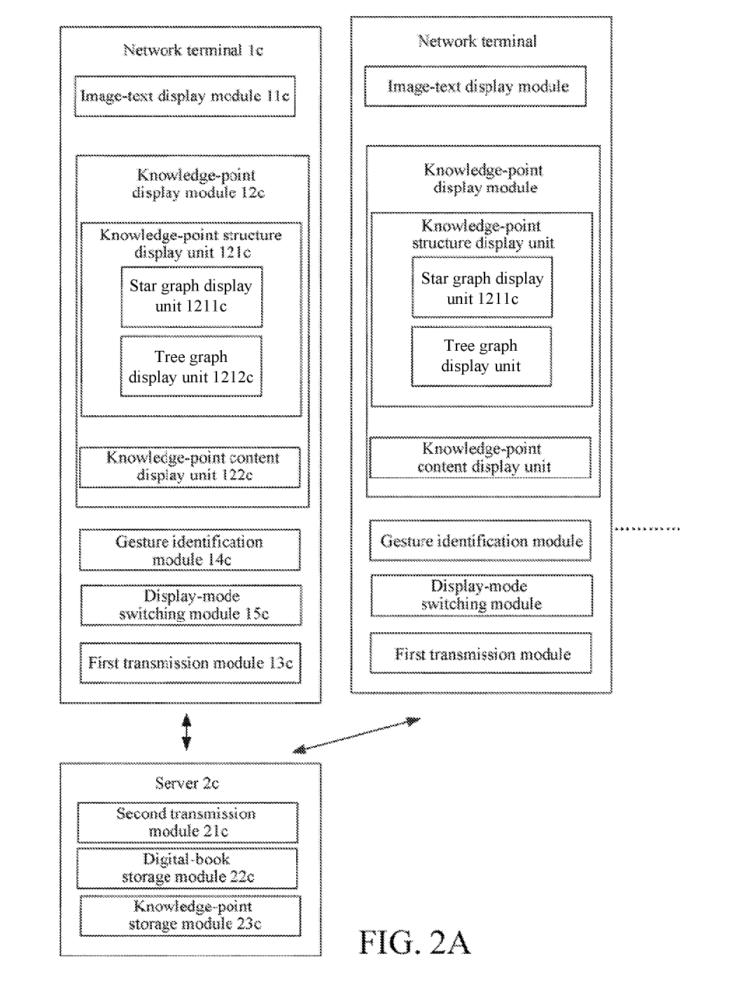

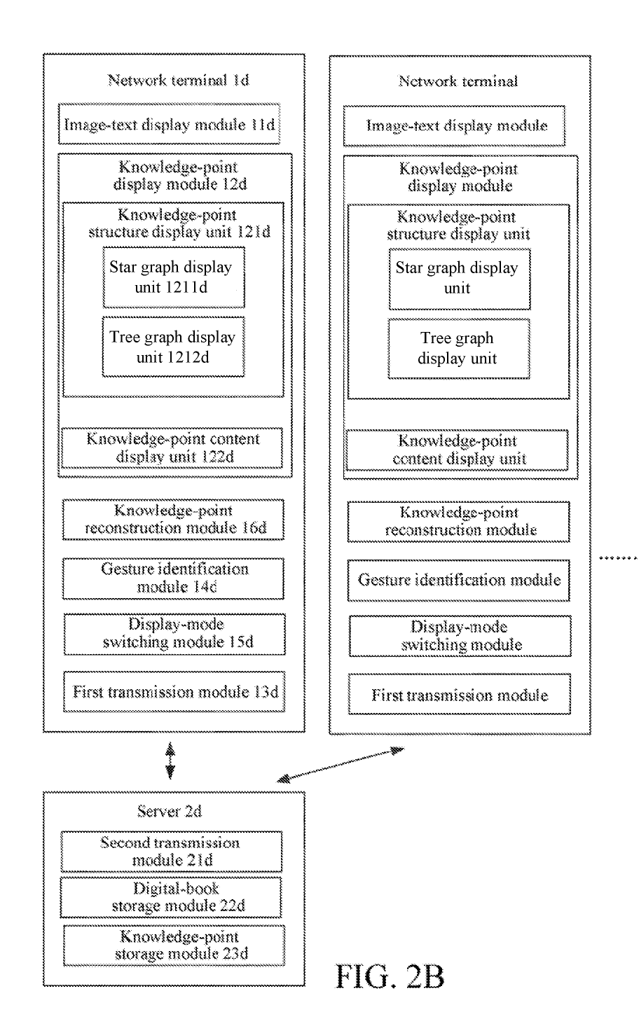

FIG. 2A shows the principle of the third embodiment of the digital-book-based learning apparatus consistent with the present invention.

The digital-book-based learning apparatus in this embodiment comprises two parts: a network terminal 1c and a server 2c. The network terminal 1c may be a computer having a network function, or a smartphone, and establishes a communication connection to the server 2c by using the Internet or a mobile Internet.

The server 2c comprises a second transmission module 21c, a digital-book storage module 22c, and a knowledge-point storage module 23c. The second transmission module 21c is configured to implement data transmission between the server 2c and the network terminal 1c. The digital-book storage module 22c is configured to store a digital book. The knowledge-point storage module is configured to store a knowledge point structure and knowledge point content that are preseted and corresponded to the digital book. The knowledge point structure comprises a classification, a structural relationship, and a label of a knowledge point. The classification of the knowledge point is a category of the knowledge point defined by an editor of the knowledge point. For example, “Belt and Road” is classified into a category of “economy” under editing of a user A, and may be classified into a category of “politics” under editing of a user B. A same knowledge point may be classified into different classifications due to different understandings of different users.

The label of the knowledge point is similar to a name of the knowledge point. For example, “Belt and Road” is a label of the knowledge point. The content of the knowledge point is a specific definition of the knowledge point. For example, a specific meaning of “Belt and Road” is content under the label of “Belt and Road”.

The structural relationship of the knowledge point is a logical relationship between knowledge points. The logical relationship is preferably indicated by using a tree data structure. Parent-child nodes are used to indicate a hyponymy relationship between the knowledge points, and brother nodes are used to indicate a parallel relationship between knowledge points. For example, a parent node of “Belt and Road” is “National Strategy”; child nodes of “Belt and Road” are “Silk Road Economic Belt”, “Maritime Silk Road”, and “Asian Infrastructure Investment Bank”; brother nodes of “Belt and Road” are “Beijing-Tianjin-Hebei Integration”, “Yangtze River Economic Zone”, “Free Trade Zone”, “Western Region Development”, “Revitalization of Northeast”, and the like.

When entering a knowledge point, an editor further enters a relationship between the knowledge point and other knowledge points in addition to content of the knowledge point. For example, for a currently entered knowledge point A and an already existing knowledge point B, a relationship between the knowledge point A and the knowledge point B may be entered while the knowledge point A is entered, and the relationship may be classified into: no relationship between A and B and a parallel relationship between A and B. If a parallel relationship exists between A and B, it indicates that granularities of A and B are the same. The parallel relationship may be further classified into three types: a causal relationship, no causal relationship but with a learning sequence, no causal relationship and no learning sequence.

No relationship or a parallel relationship (the parallel relationship is further classified into three types: a causal relationship, no causal relationship but a learning sequence, no causal relationship and no learning sequence) also exists between the currently recorded knowledge point A and a plurality of already existing knowledge points B, C, D, . . . In addition, an implication/subordinate relationship exists between the knowledge point A and the plurality of already existing knowledge points B, C, D, . . .

Each knowledge point structure and knowledge point content in the module correspond to a digital book. The knowledge point structure and knowledge point content preset in the module are preferably a knowledge point structure and knowledge point content that are established by a writer as an editor of the knowledge point structure. For example, the writer of Thirty Years of Agitation is Wu Xiaobo, and a digital book of Thirty Years of Agitation is stored in the digital-book storage module 22c. Correspondingly, the knowledge-point storage module 23c stores a knowledge point structure and knowledge point content that correspond to the book and are established by Wu Xiaobo according to knowledge points related to Thirty Years of Agitation.

The network terminal 1c comprises an image-text display module 11c, a knowledge-point display module 12c, and a first transmission module 13c. The first transmission module 13c is configured to implement data transmission between the network terminal 1c and the server 2c. The image-text display module 11c displays content of the digital book on a display screen of the network terminal 1c in an image-text manner. The digital book stored in the digital-book storage module 22c of the server is stored in the network terminal 1c by the second transmission module 21c and the first transmission module 13c, and is displayed, by the image-text display module 11c, on the display screen in a commonest image-text manner of digital books for a user to read.

In this case, the knowledge point structure stored in the knowledge-point storage module 23c of the server 2c and corresponding to the digital book is also stored in the network terminal 1c by the second transmission module 21c and the first transmission module 13c, and the knowledge point structure and knowledge point content corresponding to the digital book are then displayed by using the knowledge-point display module 12c.

The displaying of the knowledge point on the network terminal comprises two parts: one part is a position of a current knowledge point in an entire knowledge structure and relationships between the current knowledge point and other neighboring knowledge points that is a display of the knowledge point structure. The other part is specific content of the current knowledge point, that is, a display of the content of the knowledge point.

The knowledge-point display module 12c is further provided with a knowledge-point structure display unit 121c and a knowledge-point content display unit 122c. The knowledge-point structure display unit 121c displays the knowledge point structure corresponding to the digital book on a first part of the display screen of the network terminal in a first display mode, wherein the displayed knowledge point structure comprises the current knowledge point. The knowledge-point content display unit 122c displays the content of the current knowledge point on a second part of the display screen of the network terminal.

The display screen of the network terminal 1c comprises two parts, for example, an upper part and a lower part, or a left part and a right part. In this embodiment, the upper part and the lower part are used as an example for description. In this embodiment, the knowledge-point structure display unit 121c is provided with a star graph display unit 1211c. The star graph display unit 1211c displays the knowledge point structure on the upper part of display screen of the network terminal in a stargraph display mode. The displayed knowledge point structure comprises the current knowledge point. Correspondingly, the knowledge-point content display unit 122c displays the content of the current knowledge point on the lower part of the display screen of the network terminal.

The knowledge point structure displayed in the stargraph display mode is shown in FIG. 4A to FIG. 4C. In FIG. 4A, a structure of a knowledge point displayed in the star graph is displayed on the upper part of the display screen. The current knowledge point is located in the center, an upper level of the current knowledge point is a parent node, a further upper level is a grandparent node (that is, a parent node of the parent node), and so on. A lower level of the current knowledge point is child nodes, a further lower level is grandchild nodes (that is, child nodes of the child nodes), and so on. However, usually, the layer of grandchild nodes is excessively expanded, and the current knowledge point is generally suitable for being expanded to the layer of child nodes. A left node or a right node of the current knowledge point is a brother node. A connecting line is used between knowledge points to indicate a relationship between the knowledge points. In terms of a data structure, the relationship is the foregoing parent-child relationship, brother relationship, or the like. In terms of a logical relationship, the relationship may be an inclusion relationship, a time sequence relationship, a causal relationship, or the like. Preferably, an arrow direction may be further used to further indicate a cause and an effect in the causal relationship. A double-headed arrow may be used to indicate reciprocal causation.

The node in the star graph may be indicated by using a geometric shape. In this embodiment, the node is indicated by using a rectangular box. Text in the rectangular box is a label name of the knowledge point, and brightness of four edges of the rectangular box may indicate whether a relationship in terms of the knowledge point structure exists between the knowledge point and other knowledge points. For example, if a top edge of the rectangular box is highlighted, it indicates that a parent node exists above the rectangular box; if a bottom edge of the rectangular box is gray, it indicates that no child node exists below the rectangular box; similarly, a lateral edge of the rectangular box is used to indicate whether a brother node exists.

Using brightness of a line to indicate whether there is a neighboring parent node, a child node, or a brother node has an actual meaning. The star graph is usually suitable for being displayed on a touchscreen of a smartphone with a small size of screen. Therefore, only a local structure around the current knowledge point in an entire knowledge point structure system can be displayed on the screen. When a user needs to search for a knowledge point not displayed on a current interface, the user may directly move, on the touchscreen by using a gesture operation, the knowledge point displayed on the screen. The brightness of the side of the rectangular box is used to inform moving boundary. When a side of the rectangular box is highlighted, the user is informed that other node associated with the current knowledge point exists in a direction corresponding to the edge. When an edge of the rectangular box is gray, the user is informed that no other node associated with the current knowledge point exists in a direction corresponding to the edge.

For the gesture operation mentioned in the previous paragraph, correspondingly, the network terminal 1c may be further provided with a gesture identification module 14c. The gesture identification module 14c identifies an operation gesture of the user on the star graph displayed on the first part of the display screen of the network terminal, and moves, based on the gesture, the node displayed in the star graph.

For example, when the user reads the digital book of Thirty Years of Agitation, and searches for a keyword “household production” in the corresponding knowledge point structure, the network terminal executes, based on the search, a search strategy to find a knowledge point of “household production”, captures, based on displaying setting of the start graph (for example, at most 5 nodes are displayed at a level of the current knowledge point, at most 3 levels of parent nodes above the current knowledge point are displayed, at most one lower level of child nodes are displayed, and a knowledge point used as a search result is placed in the center position of the star graph), a local structure of a knowledge point system comprising the current knowledge point is captured, and correspondingly displayed on the touchscreen. If a gesture operation of the user on the touchscreen is received, the network terminal 1c re-captures, based on the gesture, a local structure of a corresponding knowledge point system from the knowledge point structure stored in the network terminal, and updates display on the touchscreen.

The knowledge-point content display unit 122c displays the content of the current knowledge point on the lower part of the display screen of the network terminal. The content comprises text content and multimedia content of the knowledge point. For example, in FIG. 4A, a left part of the lower part is the text content of the knowledge point, and a right part of the lower part is the multimedia content of the knowledge point.

FIG. 4B shows a case in which the current knowledge point is located at the top level in the entire knowledge point structure system. In this case, the user cannot move the current knowledge point upward by using a gesture any more. FIG. 4C shows a case in which the current knowledge point is located at a bottom level in the entire knowledge point structure system. In this case, the user cannot move the current knowledge point downward by using a gesture any more.

In this embodiment, the network terminal 1c displays the local structure comprising the current knowledge point on the screen by using the star graph, and displays the content of the current knowledge point at the same time. Displaying of the star graph is very suitable for a device with a small size of screen, and has a better application effect in a smartphone.

The embodiment differs from the first embodiment in that: in addition to the star graph display mode, a tree graph display mode is further provided, and the display mode may be switched, based on an input of the user, between the star graph display mode and the tree display modes.

Further referring to FIG. 2A, a display-mode switching module 15c is provided in the network terminal 1c. In addition to the star display unit 1211c, the knowledge-point structure display unit 121c is further provided with a tree-graph display unit 1212c.

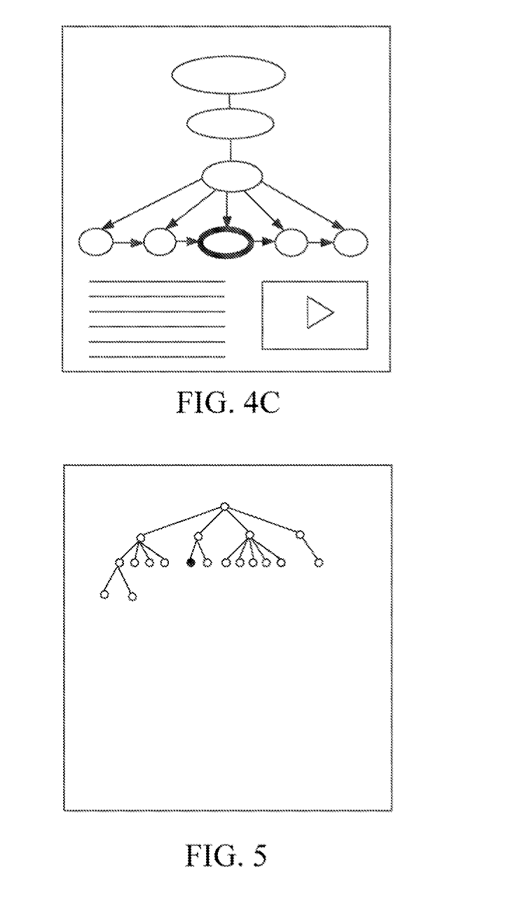

The tree display unit 1212c displays the knowledge point structure on the display screen of the network terminal in a tree-graph display mode. For a specific example, refer to FIG. 5. FIG. 5 shows a knowledge point structure system in the tree graph, and the current knowledge point is highlighted in the tree graph.

A switching button is provided on a display interface of the screen. For example, on a star graph display interface, the button is displayed as “entirety”. When the user clicks the button “entirety”, the display-mode switching module 15c receives a switching instruction, instructs the star graph display unit 1211c to stop working, and instructs the tree graph display unit 1212c to display the knowledge point structure. In this way, the star graph on the display screen is switched to the tree graph.

On the contrary, in a graph display interface, the button is displayed as “local”. When the user clicks the button “local”, the display-mode switching module 15c receives a switching instruction, instructs the tree-graph display unit 1212c to stop working, and instructs the star-graph display unit 1211c to display the knowledge point structure. In this way, the tree graph on the display screen is switched to the star graph.

In this embodiment, two display modes, that is, the star graph and the tree graph, are provided for the user. The star graph helps the user to specifically learn the knowledge point, and understand a neighboring knowledge point associated with the knowledge point. The tree graph helps the user to understand the level and a position of the current knowledge point in the entire knowledge point structure system. In addition, a function of switching between the two displays modes is provided for the user.

### Fourth Embodiment of a Digital-Book-Based Learning Apparatus

FIG. 2B shows the principle of the fourth embodiment of the digital-book-based learning apparatus according to the present invention.

The digital-book-based learning apparatus in this embodiment comprises two parts: a network terminal 1d and a server 2d. The network terminal 1d may be a computer having a network function, or a smartphone, and establishes a communication connection to the server 2d by using the Internet or a mobile Internet.

The server 2d comprises a second transmission module 21d, a digital-book storage module 22d, and a knowledge-point storage module 23d. The second transmission module 21d is configured to implement data transmission between the server 2d and the network terminal 1d. The digital-book storage module 22d is configured to store a digital book. The knowledge-point storage module is configured to store a knowledge point structure and knowledge point content that are preseted and corresponded to the digital book. The knowledge point structure comprises a classification, a structural relationship, and a label of a knowledge point. The classification of the knowledge point is a category of the knowledge point defined by an editor of the knowledge point. For example, “Belt and Road” is classified into a category of “economy” under editing of a user A, and may be classified into a category of “politics” under editing of a user B. A same knowledge point may be classified into different classifications due to different understandings of different users.

The label of the knowledge point is similar to a name of the knowledge point. For example, “Belt and Road” is a label of the knowledge point. The content of the knowledge point is a specific definition of the knowledge point. For example, a specific meaning of “Belt and Road” is content under the label of “Belt and Road”.

The structural relationship of the knowledge point is a logical relationship between knowledge points. The logical relationship is preferably indicated by using a tree data structure. Parent-child nodes are used to indicate a hyponymy relationship between the knowledge points, and brother nodes are used to indicate a parallel relationship between knowledge points. For example, a parent node of “Belt and Road” is “National Strategy”; child nodes of “Belt and Road” are “Silk Road Economic Belt”, “Maritime Silk Road”, and “Asian Infrastructure Investment Bank”; brother nodes of “Belt and Road” are “Beijing-Tianjin-Hebei Integration”, “Yangtze River Economic Zone”, “Free Trade Zone”, “Western Region Development”, “Revitalization of Northeast”, and the like.

When entering a knowledge point, an editor further enters a relationship between the knowledge point and other knowledge points in addition to content of the knowledge point. For example, for a currently entered knowledge point A and an already existing knowledge point B, a relationship between the knowledge point A and the knowledge point B may be entered while the knowledge point A is entered, and the relationship may be classified into: no relationship between A and B, or a parallel relationship between A and B. If a parallel relationship exists between A and B, it indicates that granularities of A and B are the same. The parallel relationship may be further classified into three types: a causal relationship, no causal relationship but with a learning sequence, no causal relationship and no learning sequence.

No relationship or a parallel relationship (the parallel relationship is further classified into three types: a causal relationship, no causal relationship but a learning sequence, no causal relationship and no learning sequence) also exists between the currently recorded knowledge point A and a plurality of already existing knowledge points B, C, D, . . . In addition, an implication/subordinate relationship exists between the knowledge point A and the plurality of already existing knowledge points B, C, D, . . .

Each knowledge point structure and knowledge point content in the module correspond to a digital book. The knowledge point structure and knowledge point content preset in the module are preferably a knowledge point structure and knowledge point content that are established by a writer as an editor of the knowledge point structure. For example, the writer of Thirty Years of Agitation is Wu Xiaobo, and a digital book of Thirty Years of Agitation is stored in the digital-book storage module 22d. Correspondingly, the knowledge-point storage module 23d stores a knowledge point structure and knowledge point content that correspond to the book and are established by Wu Xiaobo according to knowledge points related to Thirty Years of Agitation.

The network terminal 1d comprises an image-text display module 11d, a knowledge-point display module 12d, a first transmission module 13d, and a knowledge-point reconstruction module 15d. The first transmission module 13d is configured to implement data transmission between the network terminal 1d and the server 2d. The image-text display module 11d displays content of the digital book on a display screen of the network terminal 1d in an image-text manner. The digital book stored in the digital-book storage module 22d of the server is stored in the network terminal 1d by the second transmission module 21d and the first transmission module 13d, and is displayed, by the image-text display module 11d, on the display screen in a commonest image-text manner of digital books for a user to read.

In this case, the knowledge point structure stored in the knowledge-point storage module 23d of the server 2d and corresponding to the digital book is also stored in the network terminal 1 d by the second transmission module 21d and the first transmission module 13d, and the knowledge point structure and knowledge point content corresponding to the digital book are then displayed by using the knowledge-point display module 12d.

The display of the knowledge point on the network terminal comprises two parts: one part is a position of a current knowledge point in an entire knowledge structure and relationships between the current knowledge point and other neighboring knowledge points, that is, display of the knowledge point structure. The other part is specific content of the current knowledge point, that is, display in terms of the content of the knowledge point.

The knowledge-point display module 12d is further provided with a knowledge-point structure display unit 121d and a knowledge-point content display unit 122d. The knowledge-point structure display unit 121d displays the knowledge point structure corresponding to the digital book on a first part of the display screen of the network terminal in a first display mode, wherein the displayed knowledge point structure comprises the current knowledge point. The knowledge-point content display unit 122d displays the content of the current knowledge point on a second part of the display screen of the network terminal.

The display screen of the network terminal 1d comprises two parts, for example, an upper part and a lower part, or a left part and a right part. In this embodiment, the upper part and the lower part are used as an example for description. In this embodiment, the knowledge-point structure display unit 121d is provided with a star graph display unit 1211d. The star graph display unit 1211d displays the knowledge point structure on the upper part of display screen of the network terminal in a star graph display mode. The displayed knowledge point structure comprises the current knowledge point. Correspondingly, the knowledge-point content display unit 122d displays the content of the current knowledge point on the lower part of the display screen of the network terminal.

The knowledge point structure displayed in the star graph display mode is shown in FIG. 4A to FIG. 4C. In FIG. 4A, a structure of a knowledge point displayed in the star graph is displayed on the upper part of the display screen. The current knowledge point is located in the center, an upper level of the current knowledge point is a parent node, a further upper level is a grandparent node (that is, a parent node of the parent node), and so on. A lower level of the current knowledge point is child nodes, a further lower level is grandchild nodes (that is, child nodes of the child nodes), and so on. However, because there are too many nodes when it comes to the grandchild node, generally, the current knowledge point is preferably unfolded to the level of the child nodes. A left node or a right node of the current knowledge point is a brother node. A connecting line is used between knowledge points to indicate a relationship between the knowledge points. In terms of a data structure, the relationship is the foregoing parent-child relationship, brother relationship, or the like. In terms of a logical relationship, the relationship may be an inclusion relationship, a time sequence relationship, a causal relationship, or the like. Preferably, an arrow direction may be further used to further indicate a cause and an effect in the causal relationship. A double-headed arrow may be used to indicate reciprocal causation.

The node in the star graph may be indicated by using a geometric shape. In this embodiment, the node is indicated by using a rectangular box. Text in the rectangular box is a label name of the knowledge point, and brightness of four edges of the rectangular box may indicate whether a relationship in terms of the knowledge point structure exists between the knowledge point and other knowledge points. For example, if a top edge of the rectangular box is highlighted, it indicates that a parent node exists above the rectangular box; if a bottom edge of the rectangular box is gray, it indicates that no child node exists below the rectangular box; similarly, a lateral edge of the rectangular box is used to indicate whether a brother node exists.

Using brightness of a line to indicate whether there is a neighboring parent node, a child node, or a brother node exists has an actual meaning. The star graph is usually suitable for being displayed on a touchscreen of a smartphone with a small size of screen. Therefore, only a local structure around the current knowledge point in an entire knowledge point structure system can be displayed on the screen. When a user needs to search for a knowledge point not displayed on a current interface, the user may directly move, on the touchscreen by using a gesture operation, the knowledge point displayed on the screen. The brightness of the side of the rectangular box is used to inform moving boundary. When a side of the rectangular box is highlighted, the user is informed that other node associated with the current knowledge point exists in a direction corresponding to the edge. When an edge of the rectangular box is gray, the user is informed that no other node associated with the current knowledge point exists in a direction corresponding to the edge.

For the gesture operation mentioned in the previous paragraph, correspondingly, the network terminal 1d may be further provided with a gesture identification module 14d. The gesture identification module 14d identifies an operation gesture of the user on the star graph displayed on the first part of the display screen of the network terminal, and moves, based on the gesture, the node displayed in the star graph.

For example, when the user reads the digital book of Thirty Years of Agitation, and searches for a keyword “household production” in the corresponding knowledge point structure, the network terminal executes, based on the search, a search policy to find a knowledge point of “household production”, captures, based on displaying setting of the start graph (for example, at most 5 nodes are displayed at a level of the current knowledge point, at most 3 levels of parent nodes above the current knowledge point are displayed, at most one lower level of child nodes are displayed, and a knowledge point used as a search result is placed in the center position of the star graph), a local structure of a knowledge point system comprising the current knowledge point is captured, and correspondingly displayed on the touchscreen. If a gesture operation of the user on the touchscreen is received, the network terminal 1d re-captures, based on the gesture, a local structure of a corresponding knowledge point system from the knowledge point structure stored in the network terminal, and updates display on the touchscreen.

The knowledge-point content display unit 122d displays the content of the current knowledge point on the lower part of the display screen of the network terminal. The content comprises text content and multimedia content of the knowledge point. For example, in FIG. 4A, a left part of the lower part is the text content of the knowledge point, and a right part of the lower part is the multimedia content of the knowledge point.

FIG. 4B shows a case in which the current knowledge point is located at the top level in the entire knowledge point structure system. In this case, the user cannot move the current knowledge point upward by using a gesture any more. FIG. 4C shows a case in which the current knowledge point is located at a bottom level in the entire knowledge point structure system. In this case, the user cannot move the current knowledge point downward by using a gesture any more.

In this embodiment, the network terminal 1d displays the local structure comprising the current knowledge point on the screen by using the star graph, and displays the content of the current knowledge point at the same time. Displaying of the star graph is very suitable for a device with a small size of screen, and has a better application effect in a smartphone.

The embodiment differs from the third embodiment in that: a knowledge-point reconstruction module 16d is provided in the network terminal 1d. All the foregoing contents are understandings of the user based on the knowledge point structure given by the writer when reading, the digital book. The knowledge-point reconstruction module 16d reconstructs, based on understanding of the user on the content of the digital book, knowledge points corresponding to the digital book. A reconstructed knowledge point structure coexists with the presetting knowledge point structure of the writer in a system, and is stored in the network terminal. The knowledge point structure reconstructed by the user is transmitted to the knowledge-point storage module 23d of the server 2d by using the first transmission module for storage.

In addition to the star graph display mode, a tree graphs display mode is further provided, and the display mode may be switched, based on an input of the user, between the star graph display mode and the tree display modes.

Further referring to FIG. 2B, a display-mode switching module 15d is provided in the network terminal 1d. In addition to the star graph display unit 1211d, the knowledge-point structure display unit 121d is further provided with a tree graph display unit 1212d.

The tree graph display unit 1212d displays the knowledge point structure on the display screen of the network terminal in a tree graph display mode. For a specific example, refer to FIG. 5. FIG. 5 shows a knowledge point structure system in the tree graph, and the current knowledge point is highlighted in the tree graph.

A switching button is provided on a display interface of the screen. For example, on a star graph display interface, the button is displayed as “entirety”. When the user clicks the button “entirety”, the display-mode switching module 15d receives a switching instruction, instructs the star-graph display unit 1211d to stop working, and instructs the tree-graph display unit 1212d to display the knowledge point structure. In this way, the star graph on the display screen is switched to the tree graph.

On the contrary, in a graph display interface, the button is displayed as “local”. When the user clicks the button “local”, the display-mode switching module 15d receives a switching instruction, instructs the tree-graph display unit 1212d to stop working, and instructs the star-graph display unit 1211d to display the knowledge point structure. In this way, the tree graph on the display screen is switched to the star graph.

In this embodiment, two display modes, that is, the star graph and the tree graph are provided for the user. The star graph helps the user to specifically learn the knowledge point, and understand a neighboring knowledge point associated with the knowledge point. The tree graph helps the user to understand the level and a position of the current knowledge point in the entire knowledge point structure system. In addition, a function of switching between the two displays modes is provided for the user.

### Fifth Embodiment of a Digital-Book-Based Learning Apparatus

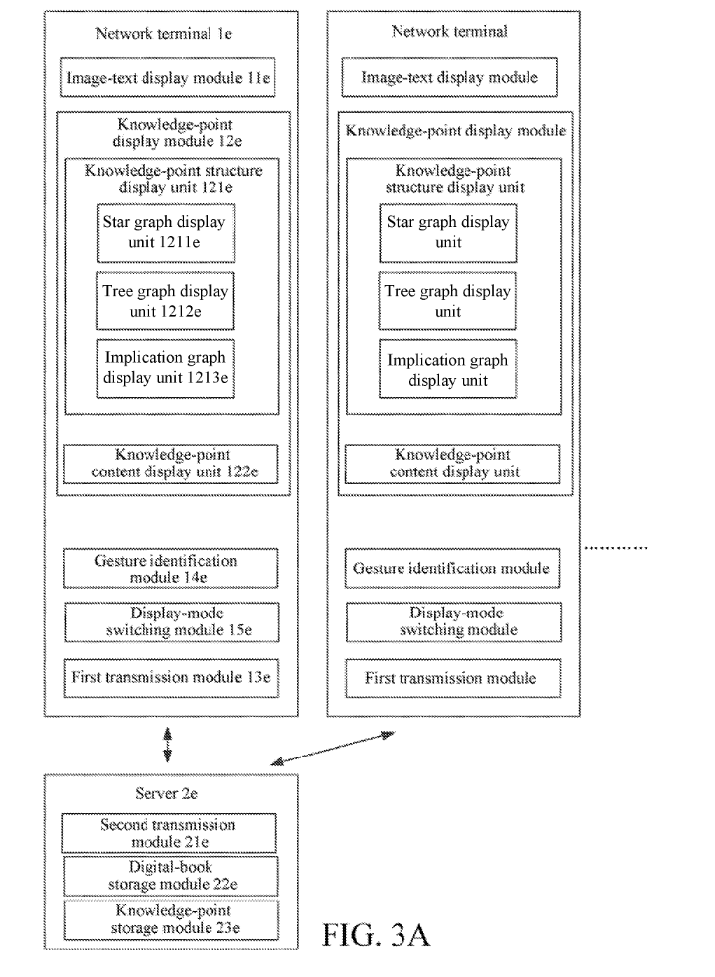

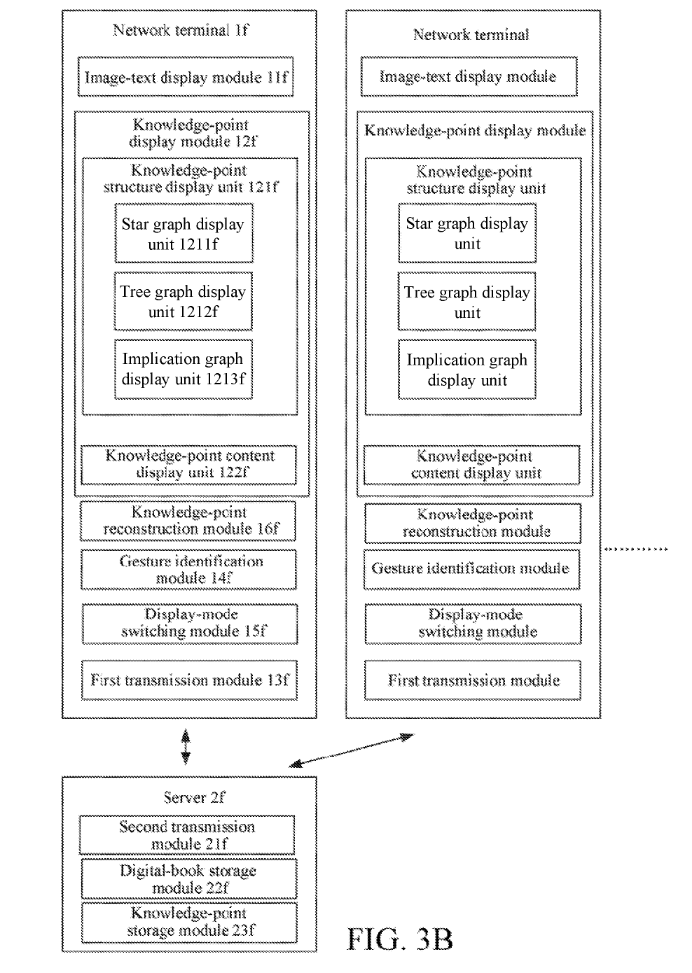

FIG. 3A shows the principle of the fifth embodiment of the digital-book-based learning apparatus according to the present invention.

The digital-book-based learning apparatus in this embodiment comprises two parts: a network terminal 1e and a server 2e. The network terminal 1e may be a computer having a network function, or a smartphone, and establishes a communication connection to the server 2e by using the Internet or a mobile Internet.

The server 2e comprises a second transmission module 21e, a digital-book storage module 22e, and a knowledge-point storage module 23e. The second transmission module 21e is configured to implement data transmission between the server 2e and the network terminal 1e. The digital-book storage module 22e is configured to store a digital book. The knowledge-point storage module 23e is configured to store a knowledge point structure and knowledge point content that are preseted and corresponded to the digital book. The knowledge point structure comprises a classification, a structural relationship, and a label of a knowledge point. The classification of the knowledge point is a category of the knowledge point defined by an editor of the knowledge point. For example, “Belt and Road” is classified into a category of “economy” under editing of a user A, and may be classified into a category of “politics” under editing of a user B. A same knowledge point may be classified into different classifications due to different understandings of different users.

The label of the knowledge point is similar to a name of the knowledge point. For example, “Belt and Road” is a label of the knowledge point. The content of the knowledge point is a specific definition of the knowledge point. For example, a specific meaning of “Belt and Road” is content under the label of “Belt and Road”.

The structural relationship of the knowledge point is a logical relationship between knowledge points. The logical relationship is preferably indicated by using a tree data structure. Parent-child nodes are used to indicate a hyponymy relationship between the knowledge points, and brother nodes are used to indicate a parallel relationship between knowledge points. For example, a parent node of “Belt and Road” is “National Strategy”; child nodes of “Belt and Road” are “Silk Road Economic Belt”, “Maritime Silk Road”, and “Asian Infrastructure Investment Bank”; brother nodes of “Belt and Road” are “Beijing-Tianjin-Hebei Integration”, “Yangtze River Economic Zone”, “Free Trade Zone”, “Western Region Development”, “Revitalization of Northeast”, and the like.

When entering a knowledge point, an editor further enters a relationship between the knowledge point and other knowledge points in addition to content of the knowledge point. For example, for a currently entered knowledge point A and an already existing knowledge point B, a relationship between the knowledge point A and the knowledge point B may be entered while the knowledge point A is entered, and the relationship may be classified into: no relationship between A and B, or a parallel relationship between A and B. If a parallel relationship exists between A and B, it indicates that granularities of A and B are the same. The parallel relationship may be further classified into three types: a causal relationship, no causal relationship but with a learning sequence, no causal relationship and no learning sequence.

No relationship or a parallel relationship (the parallel relationship is further classified into three types: a causal relationship, no causal relationship but a learning sequence, no causal relationship and no learning sequence) also exists between the currently recorded knowledge point A and a plurality of already existing knowledge points B, C, D, . . . In addition, an implication/subordinate relationship exists between the knowledge point A and the plurality of already existing knowledge points B, C, D, . . .

Each knowledge point structure and knowledge point content in the module correspond to a digital book. The knowledge point structure and knowledge point content preset in the module are preferably a knowledge point structure and knowledge point content that are established by a writer as an editor of the knowledge point structure. For example, the writer of Thirty Years of Agitation is Wu Xiaobo, and a digital book of Thirty Years of Agitation is stored in the digital-book storage module 22e. Correspondingly, the knowledge-point storage module 23e stores a knowledge point structure and knowledge point content that correspond to the book and are established by Wu Xiaobo according to knowledge points related to Thirty Years of Agitation.

The network terminal 1e comprises an image-text display module 11e, a knowledge-point display module 12e, and a first transmission module 13e. The first transmission module 13e is configured to implement data transmission between the network terminal 1e and the server 2e. The image-text display module 11e displays content of the digital book on a display screen of the network terminal 1e in an image-text manner. The digital book stored in the digital-book storage module 22e of the server is stored in the network terminal 1e by the second transmission module 21e and the first transmission module 13e, and is displayed, by the image-text display module 11e, on the display screen in a commonest image-text manner of digital books for a user to read.

In this case, the knowledge point structure stored in the knowledge-point storage module 23e of the server 2e and corresponding to the digital book is also stored in the network terminal 1e by the second transmission module 21c and the first transmission module 13e, and the knowledge point structure and knowledge point content corresponding to the digital book are then displayed by using the knowledge-point display module 12e.

The display of the knowledge point on the network terminal comprises two parts: one part is a position of a current knowledge point in an entire knowledge structure and relationships between the current knowledge point and other neighboring knowledge points, that is, display the knowledge point structure. The other part is specific content of the current knowledge point, that is, display in terms of the content of the knowledge point.

The knowledge-point display module 12e is further provided with a knowledge-point structure display unit 121e and a knowledge-point content display unit 122e. The knowledge-point structure display unit 121e displays the knowledge point structure corresponding to the digital book on a first part of the display screen of the network terminal in a first display mode, wherein the displayed knowledge point structure comprises the current knowledge point. The knowledge-point content display unit 122e displays the content of the current knowledge point on a second part of the display screen of the network terminal.

The display screen of the network terminal 1e comprises two parts, for example, an upper part and a lower part, or a left part and a right part. In this embodiment, the upper part and the lower part are used as an example for description. In this embodiment, the knowledge-point structure display unit 121e is provided with a star graph display unit 1211e. The star graph display unit 1211e displays the knowledge point structure on the upper part of display screen of the network terminal in a star graph display mode. The displayed knowledge point structure comprises the current knowledge point. Correspondingly, the knowledge-point content display unit 122e displays the content of the current knowledge point on the lower part of the display screen of the network terminal.

The knowledge point structure displayed in the star graph display mode is shown in FIG. 4A to FIG. 4C. In FIG. 4A, a structure of a knowledge point displayed in the star graph is displayed on the upper part of the display screen. The current knowledge point is located in the center, an upper level of the current knowledge point is a parent node, a further upper level is a grandparent node (that is, a parent node of the parent node), and so on. A lower layer of the current knowledge point is child nodes, a further lower level is grandchild nodes (that is, child nodes of the child nodes), and so on. However, because there are too many nodes when it comes to the grandchild node, generally, the current knowledge point is preferably unfolded to the level of the child nodes. A left node or a right node of the current knowledge point is a brother node. A connecting line is used between knowledge points to indicate a relationship between the knowledge points. In terms of a data structure, the relationship is the foregoing parent-child relationship, brother relationship, or the like. In terms of a logical relationship, the relationship may be an inclusion relationship, a time sequence relationship, a causal relationship, or the like. Preferably, an arrow direction may be further used to further indicate a cause and an effect in the causal relationship. A double-headed arrow may be used to indicate reciprocal causation.

The node in the star graph may be indicated by using a geometric shape. In this embodiment, the node is indicated by using a rectangular box. Text in the rectangular box is a label name of the knowledge point, and brightness of four edges of the rectangular box may indicate whether a relationship in terms of the knowledge point structure exists between the knowledge point and other knowledge points. For example, if a top edge of the rectangular box is highlighted, it indicates that a parent node exists above the rectangular box; if a bottom edge of the rectangular box is gray, it indicates that no child node exists below the rectangular box; similarly, a lateral edge of the rectangular box is used to indicate whether a brother node exists.

Using brightness of a line to indicate whether there is a neighboring parent node, a child node, or a brother node exists has an actual meaning. The star graph is usually suitable for being displayed on a touchscreen of a smartphone with a small size of screen. Therefore, only a local structure around the current knowledge point in an entire knowledge point structure system can be displayed on the screen. When a user needs to search for a knowledge point not displayed on a current interface, the user may directly move, on the touchscreen by using a gesture operation, the knowledge point displayed on the screen. The brightness of the side of the rectangular box is used to inform moving boundary. When a side of the rectangular box is highlighted, the user is informed that other node associated with the current knowledge point exists in a direction corresponding to the edge. When an edge of the rectangular box is gray, the user is informed that no other node associated with the current knowledge point exists in a direction corresponding to the edge.

For the gesture operation mentioned in the previous paragraph, correspondingly, the network terminal 1e may be further provided with a gesture identification module 14e. The gesture identification module 14e identifies an operation gesture of the user on the star graph displayed on the first part of the display screen of the network terminal, and moves, based on the gesture, the node displayed in the star graph.

For example, when the user reads the digital book of Thirty Years of Agitation, and searches for a keyword “household production” in the corresponding knowledge point structure, the network terminal executes, based on the search, a search policy to find a knowledge point of “household production”, captures, based on displaying setting of the start graph (for example, at most 5 nodes are displayed at a level of the current knowledge point, at most 3 levels of parent nodes above the current knowledge point are displayed, at most one lower level of child nodes are displayed, and a knowledge point used as a search result is placed in the center position of the star graph), a local structure of a knowledge point system comprising the current knowledge point is captured, and correspondingly displayed on the touchscreen. If a gesture operation of the user on the touchscreen is received, the network terminal 1e re-captures, based on the gesture, a local structure of a corresponding knowledge point system from the knowledge point structure stored in the network terminal, and updates display on the touchscreen.

The knowledge-point content display unit 122e displays the content of the current knowledge point on the lower part of the display screen of the network terminal. The content comprises text content and multimedia content of the knowledge point. For example, in FIG. 4A, a left part of the lower part is the text content of the knowledge point, and a right part of the lower part is the multimedia content of the knowledge point.

FIG. 4B shows a case in which the current knowledge point is located at the top level in the entire knowledge point structure system. In this case, the user cannot move the current knowledge point upward by using a gesture any more. FIG. 4C shows a case in which the current knowledge point is located at a bottom level layer in the entire knowledge point structure system. In this case, the user cannot move the current knowledge point downward by using a gesture any more.

In this embodiment, the network terminal 1e displays the local structure comprising the current knowledge point on the screen by using the star graph, and displays the content of the current knowledge point at the same time. Displaying of the star graph is very suitable for a device with a small size of screen, and has a better application effect in a smartphone.

In addition to the star graph display mode, a tree graph display mode and an implication graph display mode are further provided, and the display mode may be switched, based on an input of the user, between the three display modes.

Further referring to FIG. 3A, a display-mode switching module 15e is provided in the network terminal 1e. In addition to the star graph display unit 1211e, the knowledge-point structure display unit 121e is further provided with a tree graph display unit 1212e and an implication graph display unit 1213e.

The tree graph display unit 1212e displays the knowledge point structure on the display screen of the network terminal in a tree graph display mode. For a specific example, refer to FIG. 5. FIG. 5 shows a knowledge point structure system in the tree graph, and the current knowledge point is highlighted in the tree graph.

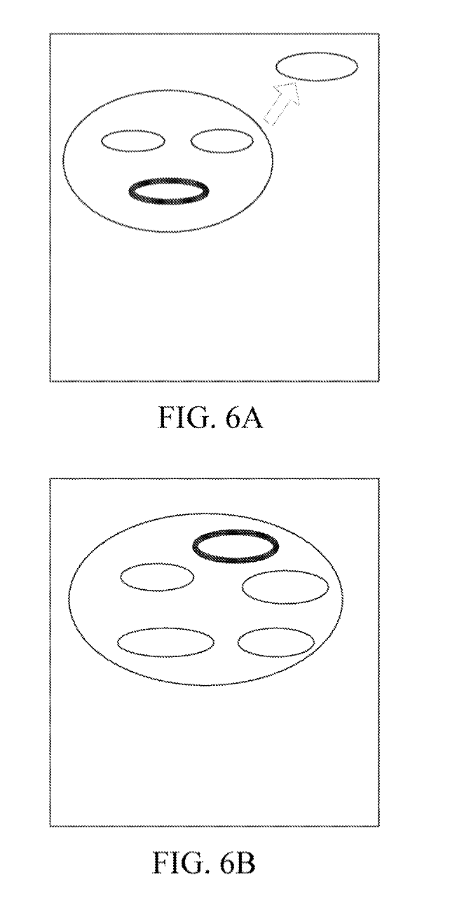

The implication graph display unit 1213e displays the knowledge point structure on the display screen of the network terminal in an implication graph display mode. For a specific example, refer to FIG. 6A and FIG. 6B. In FIG. 6A, a local set of knowledge points is mainly displayed on the interface. The current knowledge point (which is indicated by a bold line) is located in the local set, and an arrow outside the local set is used to indicate an upper-level set implicating the local set. In FIG. 6B, a highest-level set is displayed on the interface. In this case, no arrow exists to indicate an upper-level set because the set in the interface is already the set at a highest layer. The current knowledge point is indicated by a bold line. For the sets in the implication graph, a connecting line may alternatively be used to indicate that a relationship exists between the sets, and such connecting line varies in thickness. A thicker connecting line between the two sets indicates more connecting lines between fine-grained knowledge points in two sets.

A switching button is provided on a display interface of the screen. For example, on a star graph display interface, the button is displayed as “tree graph”. When the user clicks the button, the display-mode switching module 15e receives a switching instruction, instructs the star graph display unit 1211e and the implication graph display unit 1213e to stop working, and instructs the tree-graph display unit 1212e to display the knowledge point structure. In this way, the tree graph is switched to be displayed on the display screen.

In addition, “star graph” is displayed on the switching button. When the user clicks the button “star graph”, the display-mode switching module 15e receives a switching instruction, instructs the tree graph display unit 1212e and the implication graph display unit 1213e to stop working, and instructs the star graph display unit 1211e to display the knowledge point structure. In this way, the star chart is switched to be displayed on the display screen.

In addition, “implication graph” is displayed on the switching button. When the user clicks the button “implication graph”, the display-mode switching module 15e receives a switching instruction, instructs the star graph display unit 1211e and the tree graph display unit 1212e to stop working, and instructs the implication graph display unit 1213e to display the knowledge point structure. In this way, the implication graph is switched to be displayed on the display screen.

In addition to the switching operation by using the button, switching may be further performed by means of a mouse operation. For example, the star graph is displayed by default in a system. If one-click is performed, the star graph is converted into the implication graph for displaying, or if double-click is performed, the star graph is converted into the tree graph for displaying.

In this embodiment, three display modes, that is, the star graph, the tree graph, and the implication graph, are provided for the user. The star graph helps the user to specifically learn the knowledge point, and understand a neighboring knowledge point associated with the knowledge point. The tree graph helps the user to understand a level and a position of the current knowledge point in the entire knowledge point structure system. The implication graph helps the user to understand an inclusion relationship between the knowledge points. In addition, a function of switching between the three display modes is provided for the user.

### Sixth Embodiment of a Digital-Book-Based Learning Apparatus

FIG. 3B shows the principle of the sixth embodiment of the digital-book-based learning apparatus according to the present invention.

The digital-book-based learning apparatus in this embodiment comprises two parts: a network terminal 1f and a server 2f. The network terminal 1f may be a computer having a network function, or a smartphone, and establishes a communication connection to the server 2f by using the Internet or a mobile Internet.

The server 2f comprises a second transmission module 21f, a digital-book storage module 22f, and a knowledge-point storage module 23f The second transmission module 21f is configured to implement data transmission between the server 2f and the network terminal 1f. The digital-book storage module 22f is configured to store a digital book. The knowledge-point storage module 23f is configured to store a knowledge point structure and knowledge point content that are preseted and corresponded to the digital book. The knowledge point structure comprises a classification, a structural relationship, and a label of a knowledge point. The classification of the knowledge point is a category of the knowledge point defined by an editor of the knowledge point. For example, “Belt and Road” is classified into a category of “economy” under editing of a user A, and may be classified into a category of “politics” under editing of a user B. A same knowledge point may be classified into different classifications due to different understandings of different users.

The label of the knowledge point is similar to a name of the knowledge point. For example, “Belt and Road” is a label of the knowledge point. The content of the knowledge point is a specific definition of the knowledge point. For example, a specific meaning of “Belt and Road” is content under the label of “Belt and Road”.

The structural relationship of the knowledge point is a logical relationship between knowledge points. The logical relationship is preferably indicated by using a tree data structure. Parent-child nodes are used to indicate a hyponymy relationship between the knowledge points, and brother nodes are used to indicate a parallel relationship between knowledge points. For example, a parent node of “Belt and Road” is “National Strategy”; child nodes of “Belt and Road” are “Silk Road Economic Belt”, “Maritime Silk Road”, and “Asian Infrastructure Investment Bank”; brother nodes of “Belt and Road” are “Beijing-Tianjin-Hebei Integration”, “Yangtze River Economic Zone”, “Free Trade Zone”, “Western Region Development”, “Revitalization of Northeast”, and the like.

When entering a knowledge point, an editor further enters a relationship between the knowledge point and other knowledge points in addition to content of the knowledge point. For example, for a currently entered knowledge point A and an already existing knowledge point B, a relationship between the knowledge point A and the knowledge point B may be entered while the knowledge point A is entered, and the relationship may be classified into: no relationship between A and B, or a parallel relationship between A and B. If a parallel relationship exists between A and B, it indicates that granularities of A and B are the same. The parallel relationship may be further classified into three types: a causal relationship, no causal relationship but with a learning sequence, no causal relationship and no learning sequence.

No relationship or a parallel relationship (the parallel relationship is further classified into three types: a causal relationship, no causal relationship but a learning sequence, no causal relationship and no learning sequence) also exists between the currently recorded knowledge point A and a plurality of already existing knowledge points B, C, D, . . . In addition, an implication/subordinate relationship exists between the knowledge point A and the plurality of already existing knowledge points B, C, D, . . .

Each knowledge point structure and knowledge point content in the module correspond to a digital book. The knowledge point structure and knowledge point content preset in the module are preferably a knowledge point structure and knowledge point content that are established by a writer as an editor of the knowledge point structure. For example, the writer of Thirty Years of Agitation is Wu Xiaobo, and a digital book of Thirty Years of Agitation is stored in the digital-book storage module 22f. Correspondingly, the knowledge-point storage module 23f stores a knowledge point structure and knowledge point content that correspond to the book and are established by Wu Xiaobo according to knowledge points related to Thirty Years of Agitation.

The network terminal 1f comprises an image-text display module 11f, a knowledge-point display module 12f, a first transmission module 13f, and a knowledge-point reconstruction module 16f The first transmission module 13f is configured to implement data transmission between the network terminal 1f and the server 2f The image-text display module 11f displays content of the digital book on a display screen of the network terminal 1f in an image-text manner. The digital book stored in the digital-book storage module 22 of the server is stored in the network terminal 1f by the second transmission module 21f and the first transmission module 13f, and is displayed, by the image-text display module 11f, on the display screen in a commonest image-text manner of digital books for a user to read.

In this case, the knowledge point structure stored in the knowledge-point storage module 23f of the server 2f and corresponding to the digital book is also stored in the network terminal 1f by the second transmission module 21f and the first transmission module 13f, and the knowledge point structure and knowledge point content corresponding to the digital book are then displayed by using the knowledge-point display module 12f.

The display of the knowledge point on the network terminal comprises two parts: one part is a position of a current knowledge point in an entire knowledge structure and relationships between the current knowledge point and other neighboring knowledge points, that is, display the knowledge point structure. The other part is specific content of the current knowledge point, that is, display in terms of the content of the knowledge point.

The knowledge-point display module 12f is further provided with a knowledge-point structure display unit 121f and a knowledge-point content display unit 122f The knowledge-point structure display unit 121f displays the knowledge point structure corresponding to the digital book on a first part of the display screen of the network terminal in a first display mode, wherein the displayed knowledge point structure comprises the current knowledge point. The knowledge-point content display unit 122f displays the content of the current knowledge point on a second part of the display screen of the network terminal.

The display screen of the network terminal 1f comprises two parts for example, an upper part and a lower part, or a left part and a right part. In this embodiment, the upper part and the lower part are used as an example for description. In this embodiment, the knowledge-point structure display unit 121f is provided with a star graph display unit 1211f The star graph display unit 1211f displays the knowledge point structure on the upper part of display screen of the network terminal in a star graph display mode. The displayed knowledge point structure comprises the current knowledge point. Correspondingly, the knowledge-point content display unit 122f displays the content of the current knowledge point on the lower part of the display screen of the network terminal.

The knowledge point structure displayed in the star graph display mode is shown in FIG. 4A to FIG. 4C. In FIG. 4A, a structure of a knowledge point displayed in the star graph is displayed on the upper part of the display screen. The current knowledge point is located in the center, an upper level of the current knowledge point is a parent node, a further upper level is a grandparent node (that is, a parent node of the parent node), and so on. A lower layer of the current knowledge point is child nodes, a further lower level is grandchild nodes (that is, child nodes of the child nodes), and so on. However, because there are too many nodes when it comes to the grandchild node, generally, the current knowledge point is preferably unfolded to the level of the child nodes. A left node or a right node of the current knowledge point is a brother node. A connecting line is used between knowledge points to indicate a relationship between the knowledge points. In terms of a data structure, the relationship is the foregoing parent-child relationship, brother relationship, or the like. In terms of a logical relationship, the relationship may be an inclusion relationship, a time sequence relationship, a causal relationship, or the like. Preferably, an arrow direction may be further used to further indicate a cause and an effect in the causal relationship. A double-headed arrow may be used to indicate reciprocal causation.

The node in the star graph may be indicated by using a geometric shape. In this embodiment, the node is indicated by using a rectangular box. Text in the rectangular box is a label name of the knowledge point, and brightness of four edges of the rectangular box may indicate whether a relationship in terms of the knowledge point structure exists between the knowledge point and other knowledge points. For example, if a top edge of the rectangular box is highlighted, it indicates that a parent node exists above the rectangular box; if a bottom edge of the rectangular box is gray, it indicates that no child node exists below the rectangular box; similarly, a lateral edge of the rectangular box is used to indicate whether a brother node exists.

Using brightness of a line to indicate whether there is a neighboring parent node, a child node, or a brother node exists has an actual meaning. The star graph is usually suitable for being displayed on a touchscreen of a smartphone with a small size of screen large. Therefore, only a local structure around the current knowledge point in an entire knowledge point structure system can be displayed on the screen. When a user needs to search for a knowledge point not displayed on a current interface, the user may directly move, on the touchscreen by using a gesture operation, the knowledge point displayed on the screen. The brightness of the side of the rectangular box is used to inform. When a side of the rectangular box is highlighted, the user is informed that other node associated with the current knowledge point exists in a direction corresponding to the side. When an edge of the rectangular box is gray, the user is informed that no other node associated with the current knowledge point exists in a direction corresponding to the edge.

For the gesture operation mentioned in the previous paragraph, correspondingly, the network terminal 1f may be further provided with a gesture identification module 14f. The gesture identification module 14f identifies an operation gesture of the user on the star graph displayed on the first part of the display screen of the network terminal, and moves, based on the gesture, the node displayed in the star graph.

For example, when the user reads the digital book of Thirty Years of Agitation, and searches for a keyword “household production” in the corresponding knowledge point structure, the network terminal executes, based on the search, a search policy to find a knowledge point of “household production”, captures, based on displaying setting of the start graph (for example, at most 5 nodes are displayed at a level of the current knowledge point, at most 3 levels of parent nodes above the current knowledge point are displayed, at most one lower level of child nodes are displayed, and a knowledge point used as a search result is placed in the center position of the star graph), a local structure of a knowledge point system comprising the current knowledge point is captured, and correspondingly displayed on the touchscreen. If a gesture operation of the user on the touchscreen is received, the network terminal 1f re-captures, based on the gesture, a local structure of a corresponding knowledge point system from the knowledge point structure stored in the network terminal, and updates display on the touchscreen.

The knowledge-point content display unit 122f displays the content of the current knowledge point on the lower part of the display screen of the network terminal. The content comprises text content and multimedia content of the knowledge point. For example, in FIG. 4A, a left part of the lower part is the text content of the knowledge point, and a right part of the lower part is the multimedia content of the knowledge point.

FIG. 4B shows a case in which the current knowledge point is located at the top level in the entire knowledge point structure system. In this case, the user cannot move the current knowledge point upward by using a gesture any more. FIG. 4C shows a case in which the current knowledge point is located at a bottom level in the entire knowledge point structure system. In this case, the user cannot move the current knowledge point downward by using a gesture any more.

In this embodiment, the network terminal 1f displays the local structure comprising the current knowledge point on the screen by using the star graph, and displays the content of the current knowledge point at the same time. Displaying of the star graph is very suitable for a device with a small size of screen, and has a better application effect in a smartphone.

The embodiment differs from the fifth embodiment in that: the knowledge-point reconstruction module 15f is provided in the network terminal 1f. All the foregoing contents are understandings of the user based on the knowledge point structure given by the writer when reading the digital book. The knowledge-point reconstruction module 15f reconstructs, based on understanding of the user on the content of the digital book, the knowledge point structure corresponding to the digital book. A reconstructed knowledge point structure coexists with the presetting knowledge point structure of the writer in a system, and is stored in the network terminal. The knowledge point structure reconstructed by the user is transmitted to the knowledge-point storage module 23f of the server 2f by using the first transmission module for storage.

In addition to the star graph display mode, a tree graph display mode and an implication graph display mode are further provided, and the display mode may be switched, based on an input of the user, between the three display modes.

Further referring to FIG. 3B, a display-mode switching module 15f is provided in the network terminal 1f. In addition to the star graph display unit 1211f, the knowledge-point structure display unit 121f is further provided with a tree graph display unit 1212f and an implication graph display unit 1213f.

The tree graph display unit 1212f displays the knowledge point structure on the display screen of the network terminal in a tree graph display mode. For a specific example, refer to FIG. 5. FIG. 5 shows a knowledge point structure system in the tree graph, and the current knowledge point is highlighted in the tree graph.

The implication graph display unit 1213f displays the knowledge point structure on the display screen of the network terminal in an implication graph display mode. For a specific example, refer to FIG. 6A and FIG. 6B. In FIG. 6A, a local set of knowledge points is mainly displayed on the interface. The current knowledge point (which is indicated by a bold line) is located in the local set, and an arrow outside the local set is used to indicate an upper-level set implicating the local set. In FIG. 6B, a highest-level set is displayed on the interface. In this case, no arrow exists to indicate an upper-level set because the set in the interface is already the set at a highest layer. The current knowledge point is indicated by a bold line. For the sets in the implication graph, a connecting line may alternatively be used to indicate that a relationship exists between the sets, and such connecting line varies in thickness. A thicker connecting line between the two sets indicates more connecting lines between fine-grained knowledge points in two sets.

A switching button is provided on a display interface of the screen. For example, on a star graph display interface, the button is displayed as “tree graph”. When the user clicks the button, the display-mode switching module 15f receives a switching instruction, instructs the star graph display unit 1211f and the implication graph display unit 1213f to stop working, and instructs the tree graph display unit 1212f to display the knowledge point structure. In this way, the tree graph is switched to be displayed on the display screen.

In addition, “star graph” is displayed on the switching button. When the user clicks the button of “star graph”, the display-mode switching module 15f receives a switching instruction, instructs the tree graph display unit 1212f and the implication graph display unit 1213f to stop working, and instructs the star graph display unit 1211f to display the knowledge point structure. In this way, the star graph is switched to be displayed on the display screen.

In addition, “implication graph” is displayed on the switching button. When the user clicks the button “implication graph”, the display-mode switching module 15f receives a switching instruction, instructs the star graph display unit 1211f and the tree-graph display unit 1212f to stop working, and instructs the implication graph display unit 1213f to display the knowledge point structure. In this way, the implication graph is switched to be displayed on the display screen.

In addition to the switching operation by using the button, switching may be further performed by means of a mouse operation. For example, the star graph is displayed by default in a system. If one-click is performed, the star graph is converted into the implication graph for displaying, or if double-click is performed, the star graph is converted into the tree graph for displaying.

In this embodiment, three display modes, that is, the star graph, the tree graph, and the implication graph, are provided for the user. The star graph helps the user to specifically learn the knowledge point, and understand a neighboring knowledge point associated with the knowledge point. The tree graph helps the user to understand a level and a position of the current knowledge point in the entire knowledge point structure system. The implication graph helps the user to understand an inclusion relationship between the knowledge points. In addition, a function of switching between the three display modes is provided for the user.

Although the foregoing methods are shown and described as a series of actions for simplification of explaining, it should be understood and comprehended that these methods are not limited to an action sequence because according to one or more embodiments, some actions may be performed in different sequences and/or may be performed with other actions that are shown and described in this specification or other actions that are not shown or described in this specification but may be understood by a person skilled in the art.

A person skilled in art may further understand that, various explanatory logic blocks, modules, circuits, and algorithm steps described with reference to the embodiments disclosed in this specification may be implemented as electronic hardware, computer software, or a combination of the two. To clearly explain the interchangeability between the hardware and the software, various explanatory components, blocks, modules, circuits, and steps are generally described above in a functional form thereof. Whether such type of functionality is implemented as hardware or software depends on a specific application and a design constraint applied to the entire system. A skilled person may implement the described functionality in different manners for different particular applications. However, such implementation decision should not be understood as departing away from the scope of the present invention.

Various explanatory logic blocks, modules, and circuits that are described with reference to the embodiments disclosed in this specification may be implemented or executed by using a general purpose processor, a digital signal processor (DSP), an application-specific integrated circuit (ASIC), a field programmable gate array (FPGA) or other programmable logic devices, a discrete gate or transistor logic, a discrete hardware component, or any combination designed to perform the functions described in this specification. The general purpose processor may be a microprocessor. However, in an alternative solution, the processor may be any regular processor, controller, microcontroller, or state machine. The processor may be further implemented as a combination of computing devices, for example, a combination of a DSP and a microprocessor, a plurality of microprocessors, one or more microprocessors cooperating with a core of a DSP, or any other such configurations.

The steps in the methods or algorithms described with reference to the embodiments disclosed in this specification may be directly reflected in hardware, a software module executed by the processor, or a combination of the two. The software module may be resident in a RAM, a flash memory, a ROM, an EPROM, an EEPROM, a register, a hard disk, a removable disk, a CD-ROM, or any other forms of storage mediums known in the art. An exemplary storage medium is coupled to the processor, so that the processor can read information from the storage medium or write information into the storage medium. In an alternative solution, the storage medium may be integrated into the processor. The processor and the storage medium may be resident in an ASIC. The ASIC may be resident in a user terminal. In an alternative solution, the processor and the storage medium may be resident in the user terminal as discrete components.

In one or more exemplary embodiments, the described functions may be implemented in hardware, software, firmware, or any combination thereof. If the functions are implemented as a computer program product in software, each function may be stored in a computer-readable medium or transmitted by using the computer-readable medium as one or more instructions or code. The computer-readable medium comprises a computer storage medium and a communications medium, and comprises any medium that enables a computer program to be transmitted from one place to another. The storage medium may be any available medium accessible to a computer. As an example rather than limitation, such computer-readable medium may comprise a RAM, a ROM, an EEPROM, a CD-ROM or other optical disc storages, a magnetic disk storage or other magnetic storage devices, or any other mediums that can carry or store expected program code in a form of an instruction or a data structure and can be accessed by the computer. Any connection may also be appropriately defined as a computer-readable medium. For example, if software is transmitted from a website, a server, or other remote sources by using a coaxial cable, an optical fiber cable, a twisted pair, a digital subscriber line (DSL), or radio technologies such as infrared ray, radio, and microwave, the coaxial cable, the optical fiber cable, the twisted pair, the DSL, and the radio technologies such as infrared ray, radio, and microwave are comprised in a definition of the medium. A disk and disc used in this specification comprises a compact disc (CD), a laser disc, an optical disc, a digital versatile disc (DVD), a floppy disk, and a Blu-ray disc. The disk usually reproduces data by a magnetic means, and the disc usually reproduces data in an optical manner by a laser means. The foregoing combination should also be comprised in the scope of the computer-readable medium.

The prior description of the present disclosure is provided so that any person skilled in the art can produce or use the present disclosure. Various modifications of the present disclosure are obvious to a person skilled in the art, and the universally applicable principle defined in this specification may be applied to other variants without departing from the spirit or scope of the present disclosure. In this way, the present disclosure is not intended to be limited to the examples and designs that are described in this specification, but should be provided with a widest scope consistent with the principle and original features that are disclosed in this specification.

What is claimed is:

1. A digital-book-based learning apparatus, comprising a network terminal and a server, wherein
the network terminal comprises:
an image-text display module, configured to display content of a digital book on a display screen of the network terminal in an image-text manner;
a knowledge-point display module, configured to display a knowledge point structure and knowledge point content of the digital book; and
a first transmission module, configured to perform data transmission with the server; and
the server comprises:
a digital-book storage module, configured to store the digital book;
a knowledge-point storage module, configured to store a knowledge point structure and knowledge point content that are preseted and corresponded to the digital book, wherein the knowledge point structure comprises a classification, a structural relationship, and a label of a knowledge point; and
a second transmission module, configured to perform data transmission with the network terminal.

2. The digital-book-based learning apparatus according to as in claim 1, wherein the network terminal further comprises:
a knowledge-point reconstruction module, configured to reconstruct, based on understanding of a user on the content of the digital book, the knowledge point structure corresponding to the digital book.

3. The digital-book-based learning apparatus according to in claim 2, wherein a knowledge point structure reconstructed by the user in the knowledge-point reconstruction module is transmitted to the knowledge-point storage module of the server by the first transmission module for storage.

4. The digital-book-based learning apparatus according to in claim 1, wherein the knowledge-point display module comprises:
a knowledge-point structure display unit, configured to display the knowledge point structure corresponding to the digital book on a first part of the display screen of the network terminal in a first display mode, wherein the displayed knowledge point structure comprises a current knowledge point; and
a knowledge-point content display unit, configured to display content of the current knowledge point on a second part of the display screen of the network terminal.

5. The digital-book-based learning apparatus according to in claim 4, wherein the knowledge-point structure display unit comprises a star graph display unit, wherein the star graph display unit is configured to display the knowledge point structure on the first part of the display screen of the network terminal in a star graph display mode.

6. The digital-book-based learning apparatus according to in claim 5, wherein the knowledge-point structure display unit is further configured to display the knowledge point structure on the first part of the display screen of the network terminal in a second display mode, wherein the displayed knowledge point structure comprises the current knowledge point; and
the network terminal further comprises:
a display-mode switching module, configured to receive an input of a user to perform switching between the first display mode and the second display mode.

7. The digital-book-based learning apparatus according to in claim 6, wherein the second display mode is a tree graph display mode, the knowledge-point structure display unit further comprises a tree graph display unit, and the tree graph display unit is configured to display the knowledge point structure on the first part of the display screen of the network terminal in a tree graph display mode.

8. The digital-book-based learning apparatus according to in claim 5, wherein the structural relationship of the knowledge point is displayed by using the knowledge-point structure display unit in the star graph display mode, N parent nodes, N neighboring brother nodes, and N child nodes using the current knowledge point as a center are displayed on the first part of the display screen of the network terminal, wherein N is a natural number greater than or equal to 1, the label of the knowledge point is displayed at the node in the star graph, and a connecting line or an arrow between the nodes indicate a structural relationship between knowledge points.

9. The digital-book-based learning apparatus according to in claim 5, wherein the node in the star graph is indicated by a rectangular box, text in the rectangular box is the label of the knowledge point, and brightness of a edge of the rectangular box indicates whether there is structural relationship between the knowledge points.

10. The digital-book-based learning apparatus according to in claim 8, wherein the network terminal further comprises:
a gesture identification module, configured to identify an operation gesture of a user on the star graph displayed on the first part of the display screen of the network terminal, and move, based on the gesture, the node displayed in the star graph.

11. The digital-book-based learning apparatus according to in claim 7, wherein the knowledge-point structure display unit is further configured to display the knowledge point structure on the first part of the display screen of the network terminal in a third display mode, wherein the third display mode is an implication graph display mode; the knowledge-point structure display unit further comprises an implication graph display unit, and the implication graph display unit is configured to display the knowledge point structure on the first part of the display screen of the network terminal in the implication graph display mode; and the display-mode switching module is configured to receive the input of the user to perform switching between the first display mode, the second display mode, and the third display mode.
